(19) United States
(12) Patent Application Publication
(10) Pub. No.: US 2023/0422242 A1
(43) Pub. Date: Dec. 28, 2023

(54) Multiplexing Of Configured Grant-UCI (CG-UCI) And Uplink Control Information (UCI) In Shared Frequency Bands

(71) Applicant: QUALCOMM Incorporated, San Diego, CA (US)

(72) Inventors: Shaozhen GUO, Beijing (CN); Xiaoxia ZHANG, San Diego, CA (US); Changlong XU, Beijing (CN); Jing SUN, San Diego, CA (US); Rajat PRAKASH, San Diego, CA (US); Hao XU, Beijing (CN)

(21) Appl. No.: 18/253,239

(22) PCT Filed: Jan. 14, 2021
(86) PCT No.: PCT/CN2021/071758

§ 371 Date: May 17, 2023

(51) Int. Cl. H04W 72/1268; H04W 72/21; H04W 72/566; H04L 1/1812

(52) U.S. Cl. CPC H04W 72/1268; H04W 72/21; H04W 72/566; H04L 1/1812

(57) ABSTRACT

Wireless communication systems and methods related to multiplexing of uplink control information (UCI) and configured grant-UCI (CG-UCI) of different priorities are provided. A user equipment (UE) determines that a physical uplink control channel (PUCCH) resource at least partially overlaps with a configured grant physical uplink shared channel (CG-PUSCH) resource, where the PUCCH resource and the CG-PUSCH resource are associated with different priorities. The UE, based on a threshold number of bits, a number of bits of a low-priority uplink control information (UCI) for multiplexing with at least one of a high-priority CG-PUSCH transmission, a low-priority CG-PUSCH transmission, or a high-priority UCI. The UE multiplexes the number of bits of the low-priority UCI with the at least one of the high-priority CG-PUSCH transmission, the low-priority CG-PUSCH transmission, or the high-priority UCI to generate a multiplexed uplink transmission, and transmits the multiplexed uplink transmission in the PUCCH resource or the CG-PUSCH resource.

### TECHNICAL FIELD

This application relates to wireless communication systems and methods, and more particularly to multiplexing of configured grant-UCI (CG-UCI) and uplink control information (UCI) of different priorities in shared frequency bands.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BS s), each simultaneously supporting communications for multiple communication devices, which may be otherwise known as user equipment (UE).

To meet the growing demands for expanded mobile broadband connectivity, wireless communication technologies are advancing from the long-term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

One approach to avoiding collisions when communicating in a shared spectrum or an unlicensed spectrum is to use a listen-before-talk (LBT) procedure to ensure that the shared channel is clear before transmitting a signal in the shared channel. For example, a transmitting node may perform LBT to determine whether there are active transmissions in the channel. If the LBT results in an LBT pass, the transmitting node may transmit a preamble to reserve a channel occupancy time (COT) in the shared channel and may communicate with a receiving node during the COT.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One aspect of the present disclosure includes a method of wireless communication performed by a user equipment (UE). The method includes determining that a physical uplink control channel (PUCCH) resource at least partially overlaps with a configured grant physical uplink shared channel (CG-PUSCH) resource, where the PUCCH resource and the CG-PUSCH resource are associated with different priorities. The method also includes determining, based on a threshold number of bits, a number of bits of a low-priority uplink control information (UCI) for multiplexing with at least one of a high-priority CG-PUSCH transmission, a low-priority CG-PUSCH transmission, or a high-priority UCI. The method also includes multiplexing the number of bits of the low-priority UCI with the at least one of the high-priority CG-PUSCH transmission, the low-priority CG-PUSCH transmission, or the high-priority UCI to generate a multiplexed uplink transmission. The method also includes transmitting the multiplexed uplink transmission in the PUCCH resource or the CG-PUSCH resource.

One aspect of the present disclosure includes a user equipment (UE). The UE includes a processor configured to: determine that a physical uplink control channel (PUCCH) resource at least partially overlaps with a configured grant physical uplink shared channel (CG-PUSCH) resource, where the PUCCH resource and the CG-PUSCH resource are associated with different priorities; determine, based on a threshold number of bits, a number of bits of a low-priority uplink control information (UCI) for multiplexing with at least one of a high-priority CG-PUSCH transmission, a low-priority CG-PUSCH transmission, or a high-priority UCI; and multiplex the number of bits of the low-priority UCI with the at least one of the high-priority CG-PUSCH transmission, the low-priority CG-PUSCH transmission, or the high-priority UCI to generate a multiplexed uplink transmission. The UE also includes a transceiver configured to transmit the multiplexed uplink transmission in the PUCCH resource or the CG-PUSCH resource.

One aspect of the present disclosure includes a non-transitory computer-readable medium having program code stored thereon. The program code includes: code for causing a user equipment (UE) to determine that a physical uplink control channel (PUCCH) resource at least partially overlaps with a configured grant physical uplink shared channel (CG-PUSCH) resource, where the PUCCH resource and the CG-PUSCH resource are associated with different priorities. The program code also includes code for causing the UE to determine, based on a threshold number of bits, a number of bits of a low-priority uplink control information (UCI) for multiplexing with at least one of a high-priority CG-PUSCH transmission, a low-priority CG-PUSCH transmission, or a high-priority UCI. The program code also includes code for causing the UE to multiplex the number of bits of the low-priority UCI with the at least one of the high-priority CG-PUSCH transmission, the low-priority CG-PUSCH transmission, or the high-priority UCI to generate a multiplexed uplink transmission. The program code also includes code for causing the UE to transmit the multiplexed uplink transmission in the PUCCH resource or the CG-PUSCH resource.

One aspect of the present disclosure includes a user equipment (UE). The UE includes means for determining that a physical uplink control channel (PUCCH) resource at least partially overlaps with a configured grant physical uplink shared channel (CG-PUSCH) resource, where the PUCCH resource and the CG-PUSCH resource are associated with different priorities. The UE also includes means for determining, based on a threshold number of bits, a number of bits of a low-priority uplink control information (UCI) for multiplexing with at least one of a high-priority CG-PUSCH transmission, a low-priority CG-PUSCH transmission, or a high-priority UCI. The UE also includes means for multiplexing the number of bits of the low-priority UCI with the at least one of the high-priority CG-PUSCH transmission, the low-priority CG-PUSCH transmission, or the high-priority UCI to generate a multiplexed uplink transmission. The UE also includes means for transmitting the multiplexed uplink transmission in the PUCCH resource or the CG-PUSCH resource.

Other aspects and features aspect of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 illustrates a wireless communication network according to some aspects of the present disclosure.

FIG. 2 illustrates a radio frame structure according to some aspects of the present disclosure.

FIG. 3 illustrates a scheduling/configuration timeline according to one or more aspects of the present disclosure.

FIG. 4A is a flow diagram for handling collision between configured grant-uplink control information (CG-UCI) and scheduled UCI of different priorities according to one or more aspects of the present disclosure.

FIG. 4B is a flow diagram for handling collision between configured grant-uplink control information (CG-UCI) and scheduled UCI of different priorities according to one or more aspects of the present disclosure.

FIG. 5 illustrates a multiplexing scheme for handling a collision between scheduled UCI and CG-UCI associated with different priorities according to one or more aspects of the present disclosure.

FIG. 6 illustrates a multiplexing scheme for handling a collision between scheduled UCIs associated with different priorities according to one or more aspects of the present disclosure.

FIG. 7 illustrates a multiplexing scheme for handling a collision between scheduled UCI and CG-UCI associated with different priorities according to one or more aspects of the present disclosure.

FIG. 8A illustrates a scheme for bundling a HARQ-ACK communication according to one or more aspects of the present disclosure.

FIG. 8B illustrates a scheme for bundling a HARQ-ACK communication according to one or more aspects of the present disclosure.

FIG. 8C illustrates a scheme for truncating low-priority UCI or CG-UCI according to one or more aspects of the present disclosure.

FIG. 8D illustrates a scheme for truncating low-priority UCI or CG-UCI according to one or more aspects of the present disclosure.

FIG. 9 is a block diagram of an exemplary user equipment (UE) according to some aspects of the present disclosure.

FIG. 10 is a block diagram of an exemplary base station (BS) according to some aspects of the present disclosure.

FIG. 11 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜0.99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

In a wireless communication network, a base station (BS) may schedule a user equipment (UE) for UL and/or DL communications via a dynamic scheduling or a configured grant (CG) procedure. For dynamic scheduling, the BS may transmit a scheduling assignment or grant to schedule the UE for each and every UL transmission and/or each and every DL transmission. On the other hand, for CG-based transmissions, the BS may configure the UE with a set of resources, which may be referred to as CG resources, and the UE may transmit or receive in any of the CG resources without receiving a specific scheduling grant from the BS for each CG resource. There are two types of CGs, a CG type 1 and a CG type 2. For a CG type 1, the BS may preconfigure the UE with a CG configuration indicating an allocated resource and a periodicity for the allocated resource. For a CG type 2, the BS may preconfigure the UE with a CG configuration indicating a periodicity. The BS may activate the CG configuration by indicating a resource allocation for the CG configuration. Once activated, the resource allocation may repeat according to the preconfigured periodicity. In some instances, a CG transmission in a CG resource may also be referred to as a grant-less transmission, a grant-free transmission an unscheduled transmission, or an autonomous transmission.

Since the UE may transmit an uplink CG transmission (e.g., a CG-physical uplink shared channel (PUSCH) transmission) in a CG resource without receiving a scheduling grant from the BS, the UE may include CG-UCI in each CG transmission to facilitate reception and/or decoding of the CG transmission at the BS. For instance, the CG-UCI may indicate hybrid automatic repeat request (HARQ) information, such as a HARQ identifier (ID), a new data indicator (NDI), and/or a revision (RV) ID, related to the CG uplink data in the CG transmission. In some instances, the UE may transmit the CG transmission over a shared radio frequency band (e.g., in a shared spectrum or an unlicensed spectrum), and thus the UE may perform a listen-before-talk (LBT) to contend for a channel occupancy time (COT) in the shared channel. Upon gaining the COT, the UE may transmit the CG-transmission during a portion of the COT and may share a remaining portion with a BS. To indicate that the COT is for sharing, the UE may further include COT sharing information the CG-UCI.

The deployment of NR over an unlicensed band, for example, at about 3.5 gigahertz (GHz), sub-6 GHz or higher frequencies in the mmWave band, may be referred to as NR-U. In some aspects, it may be desirable for a BS to communicate ultra-reliable low-latency communication (URLLC) with a UE using both dynamic scheduling and a configured grant procedure. For URLLC in NR-U, the BS may assign a two-level priority (e.g., a high traffic priority or a low traffic priority) for each scheduled UCI transmission and a two-level priority for each CG-PUSCH transmission including CG-UCI. In some instances, a resource scheduled for a UCI transmission may partially overlap with an uplink CG resource or fully overlap with an uplink CG resource. Some examples of scheduled UCI transmissions may include, but not limited to, hybrid automatic repeat request-acknowledgement (HARQ-ACK) information and/or channel state information (CSI) reports. A CSI report may include information related to CSI-RS resource indicator (CRI), rank indicator (RI), layer indicator (LI), wideband channel quality indicator (CQI), and/or subband differential CQI, and/or precoding matrix indicator (PMI), determined based on a reference signal (e.g., a CSI-RS) in a DL communication. In some instances, a CSI report may be divided into a CSI part 1 and a CSI part 2, where the CSI part 1 may include RI, CRI, and/or CQI, and the CSI part 2 may include PMI and/or subband differential CQI. In some instances, the CSI may be periodic CSI, configured via a RRC configuration, or semi-persistent CSI activated via a medium access control (MAC) control element (CE) by a BS.

As used herein, the term “UCI” can refer to UCI scheduled by a BS via a dynamic scheduling grant (e.g., downlink control information (DCI)) and/or UCI (e.g., CSI) configured by a BS via RRC or MAC CE for transmission in a physical uplink control channel (PUCCH). As used herein, the term “CG-UCI” can refer to control information include in a CG-PUSCH transmission for providing information related to CG UL data (unscheduled data) in the CG-PUSCH transmission.

In some instances, a UE may receive a UCI transmission schedule in a time period that partially or fully overlaps with an uplink CG resource for a CG-PUSCH transmission including CG-UCI. In other words, the UCI transmission may collide with the CG-PUSCH transmission. There are various rules for handling collisions between a scheduled UCI transmission and a CG-PUSCH transmission including CG-UCI. However, the rules are limited to handling collision between scheduled UCI and CG-UCI of the same traffic priorities.

The present disclosure describes mechanisms for multiplexing UCI and CG-UCI of different traffic priorities in shared radio frequency bands, such as NR-U. For example, a BS may schedule a UE for UL communication via dynamic scheduling grants. The UL communications may include PUSCH transmissions carrying UL data and/or PUCCH transmissions carrying UCI (e.g., HARQ-ACK information). Each scheduling grant may indicate a traffic priority (e.g., a low-priority or a high-priority) for a corresponding UL transmission. The BS may also configure the UE with PUCCH resources for CSI reporting (e.g., UCI), which may be of a low traffic priority. The BS may further configure the UE with CG grants indicating CG resources for UL communications (e.g., CG-PUSCH transmissions). Each configured grant may also indicate a traffic priority (e.g., a low-priority or a high-priority) for a corresponding CG resource. A CG-PUSCH transmission may include CG UL data (unscheduled UL data) and CG-UCI providing information (e.g., HARQ process ID, RV, new data indicator (NDI)) related to the CG UL data. In some aspects, the UE may determine that a UCI message (e.g., including HARQ-ACK information) associated with a first priority is scheduled in a time period that at least partially overlaps (collides) with a CG resource for a CG-PUSCH transmission associated with a second priority different from the first priority. In some aspects, the UE may resolve the collision by multiplexing a low-priority UCI message (e.g., HARQ-ACK information) with at least one of a high-priority UCI message, low-priority CG-UCI, and/or high-priority CG-UCI. The UE may multiplex the UCI and CG communications based on a configured number of bits, or threshold number of bits. The threshold number of bits can be predefined or configured by RRC. For example, the UE may determine to compress a low-priority UCI message and/or a low-priority CG-UCI communication based on the configured threshold number of bits. In some aspects, compression may include truncating low-priority CSI and/or low-priority CG-UCI. For instance, low-priority CSI may include multiple information parts. Similarly, low-priority CG-UCI may include multiple information parts. The truncation may include excluding one or more information parts for the multiplexing. In some aspects, the truncation or compression may be based on certain configured rules. In some aspects, compression may include bundling multiple HARQ-ACK bits for multiple transport blocks (TB s) into 1 or 2 bits. The compressed low-priority UCI and/or CG-UCI may be appended and multiplexed with a high-priority UCI and/or high-priority CG-UCI and transmitted to the BS. In some aspects, the UE may be configured to transmit the multiplexed UCI and CG communications in a CG-PUSCH or in a PUCCH based on determining whether multiplexing of HARQ-ACK with CG-UCI is enabled when HARQ-ACK is scheduled for transmission in the overlapping time period.

Accordingly, the UE may resolve or manage the colliding resources in a manner that reduces the amount and frequency of dropped communications, while ensuring that important high-priority communications (e.g., HARQ-ACK associated with URLLC communications) are transmitted to the BS in the overlapping time period. Additionally, the use of a threshold number of bits for low-priority UCI to be multiplexed with a high-priority CG-PUSCH or high-priority HARQ-ACK allows low-priority communication to be transmitted to the BS as well, but with a controllable number of bits. Further, the use of truncation or compression of low-priority UCI and/or low-priority CG-UCI based on rules may allow for certain low-priority communication to be dropped in an orderly manner.

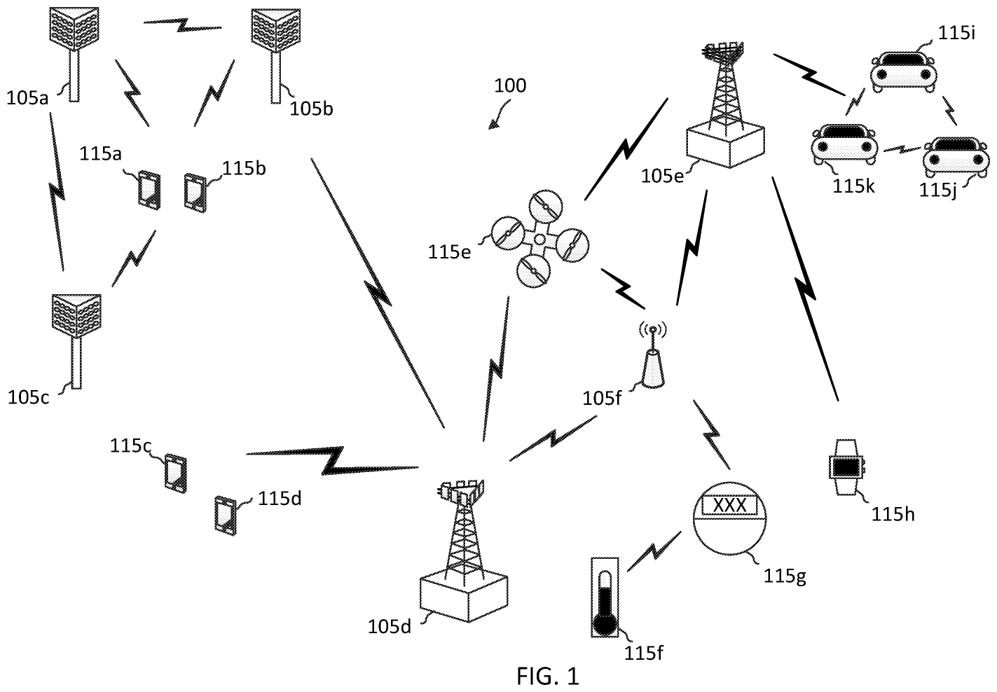

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRS s) and/or channel state information—reference signals (CSI-RS s) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a back-off indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands and/or unlicensed frequency bands. For example, the network 100 may be an NR-U network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. A TXOP may also be referred to as channel occupancy time (COT). For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

An LBT can be based on energy detection (ED) or signal detection. For an energy detection-based LBT, the LBT results in a pass when signal energy measured from the channel is below a threshold. Conversely, the LBT results in a failure when signal energy measured from the channel exceeds the threshold. An LBT may include one, two, or more clear channel assessments (CCAs) performed during successive time periods. For a signal detection-based LBT, the LBT results in a pass when a channel reservation signal (e.g., a predetermined preamble signal) is not detected in the channel. Additionally, an LBT may be in a variety of modes. An LBT mode may be, for example, a category 4 (CAT4) LBT, a category 2 (CAT2) LBT, or a category 1 (CAT1) LBT. A CAT1 LBT is referred to a no LBT mode, where no LBT is to be performed prior to a transmission. A CAT2 LBT refers to an LBT without a random back-off period. For instance, a transmitting node may determine a channel measurement in a time interval and determine whether the channel is available or not based on a comparison of the channel measurement against a ED threshold. A CAT4 LBT refers to an LBT with a random back-off and a variable contention window (CW). For instance, a transmitting node may draw a random number and back-off for a duration based on the drawn random number in a certain time unit.

In some aspects, a BS 105 may utilize both dynamic scheduling and a CG procedure for communications with a UE 115. For dynamic scheduling, the BS 105 may transmit a scheduling assignment or grant to schedule the UE 115 for each and every UL transmission and/or each and every DL transmission. For CG-based communications, the BS 105 may configure the UE 115 with a set of resources, which may be referred to as CG resources, and the UE 115 may transmit or receive in any of the CG resources without receiving a specific scheduling grant from the BS 105 for each CG resource.

In some aspects, the network 100 may provision for URLLC, for example, over an unlicensed band. The network 100 may provision for two traffic priority levels (e.g., a high-priority and a low-priority) for UCI transmissions and two traffic two traffic priority levels (e.g., a high-priority and a low-priority) for CG-PUSCH transmissions. As discussed above, each CG transmission may include CG-UCI. In some instances, a UE 115 may receive a UCI transmission schedule in a time period that partially or fully overlaps with an uplink CG resource for a CG-PUSCH transmission including CG-UCI.

According to an aspect of the present disclosure, when a UE 115 determines that a first resource for an uplink transmission (e.g., a UCI transmission or a CG-PUSCH transmission) associated with a first priority (e.g., a traffic priority) at least partially overlaps with a second resource for a CG-PUSCH transmission associated with a second priority (e.g., a traffic priority) different from the first priority, the UE 115 may multiplex at least a portion of the UL transmission scheduled in the first resource with the UL transmission scheduled in the second resource. In some instances, one of the first priority or second priority may be associated with a high-priority traffic, such as enhanced mobile broadband (eMBB) traffic, while the other one of the first priority or second priority may be associated with a low-priority traffic, such as URLLC traffic. The multiplexing may include determining a number of low-priority UCI bits for multiplexing based on a predefined or configured threshold. Mechanisms for handling a resource overlap or a collision between a UCI transmission and a CG-PUSCH transmission (including. CG-UCI) of different traffic priorities are discussed in greater detail herein.

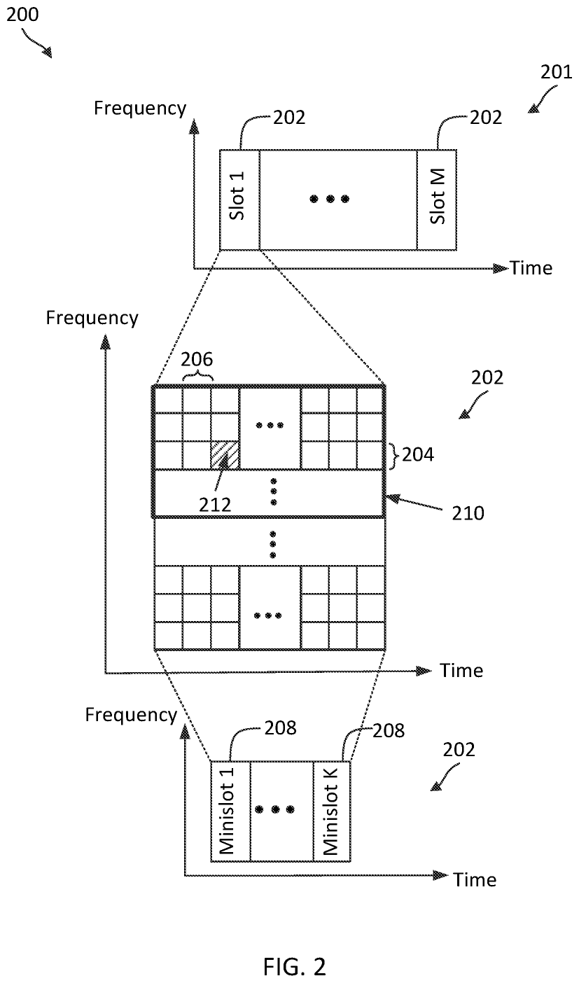

FIG. 2 illustrates a radio frame structure 200 according to some aspects of the present disclosure. The radio frame structure 200 may be employed by BSs such as the BSs 105 and UEs such as the UEs 115 in a network such as the network 100 for communications. In FIG. 2, the x-axes represent time in some arbitrary units and the y-axes represent frequency in some arbitrary units. The transmission frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel bandwidth, the subcarrier spacing (SCS), and/or the CP mode. One subcarrier 204 in frequency and one symbol 206 in time forms one resource element (RE) 212 for transmission. A resource block (RB) 210 is formed from a number of consecutive subcarriers 204 in frequency and one or more consecutive symbols 206 in time. In NR, a RB 210 is defined as twelve consecutive subcarriers 204 in a frequency domain.

In an example, a BS (e.g., BS 105 in FIG. 1) may schedule a UE (e.g., UE 115 in FIG. 1) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N−1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204).

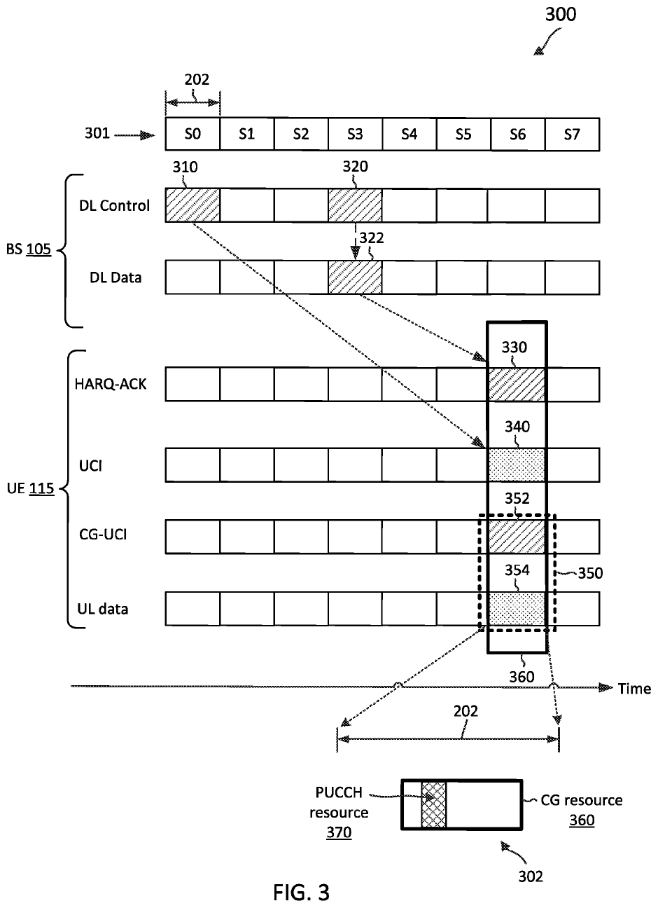

FIG. 3 illustrates a scheduling/configuration timeline 300 according to one or more aspects of the present disclosure. The scheduling/configuration timeline 300 may correspond to a scheduling/configuration timeline communicated between a BS 105 and a UE 115 of the network 100. In FIG. 3, the x-axis represents time in some constant units. FIG. 3 shows a frame structure 301, which may correspond to a portion of the frame structure 200 of FIG. 2. As shown, the frame structure 301 includes a plurality of slots 202 in time. The slots 202 are indexed from S0 to S9. For instance, a BS 105 may communicate with a UE 115 in units of slots 202. The slots 202 may also be referred to as transmission time intervals (TTIs). Each slot 202 or TTI carries a medium access control (MAC) layer transport block. Each slot 202 may include a number of symbols in time and a number of frequency tones in frequency. Each slot 202 may include a DL control portion followed by at least one of a subsequent DL data portion, UL data portion, and/or a UL control portion. In the context of LTE or NR, the DL control portion, the DL data portion, the UL data portion, and the UL control portion may be referred to as a physical downlink control channel (PDCCH), a physical downlink shared channel (PDSCH), a physical uplink shared channel (PUSCH), and a physical uplink control channel (PUCCH), respectively.

The pattern-filled boxes represent transmissions of DL control information (DCI), DL data, UL control information (UCI), UL data, an ACK, and/or a NACK in corresponding slots 202. While an entire slot 202 is pattern-filled, a transmission may occur only in a corresponding portion of the slot 202. As shown, the BS 105 transmits DCI 310 in the slot 202 indexed S0 (e.g., in a DL control portion of the slot 202). The DCI 310 may indicate a UL grant for the UE 115. The UE 115 transmits the UCI 340 to the BS 105 in the slot 202 indexed S6 (e.g., in a UL control portion of the slot 202) based on the UL assignment or RRC configuration or MAC CE. The slot 202 indexed S4 is a fourth slot from the slot 202 indexed S0. In an example, the UCI 340 may be a CSI report which is configured by RRC or activated by medium access control (MAC) control element (CE). As discussed above, a CSI report may include a CSI part 1 and a CSI part 2. Thus, in some instances, the UCI 340 may include CSI part 1 (e.g., including an RI, a CRI, and/or a wideband CQI) and CSI part 2 (e.g., PMI and/or a subband CQI).

Further, the BS 105 transmits DCI 320 in the slot 202 indexed S3 (e.g., in a DL control portion of the slot 202). The DCI 320 may indicate a DL grant for the UE 115 in the same slot 202 indexed S3. Thus, the BS 105 transmits a DL data signal 322 to the UE 115 in the slot 202 indexed S3 (e.g., in a DL data portion of the slot 202). The UE 115 may receive the DCI 320 and receive the DL data signal 322 based on the DL grant. The DL data signal 322 is a scheduled DL, which is granted by a DL grant indicated in the DCI 320.

In some aspects, the BS 105 may employ HARQ techniques as discussed above in relation to FIG. 1 for the transmission of the DL data signal 322. Accordingly, after receiving the DL data signal 322, the UE 115 may report a reception status of the DL data signal 322 to the BS 105 by transmitting HARQ-ACK information 330. The HARQ-ACK information 330 refers to a feedback of an ACK or a NACK. The feedback may be an ACK indicating that reception of the DL data by the UE 115 is successful or may be an NACK indicating that reception of the DL data by the UE 115 is unsuccessful (e.g., including an error or failing an error correction). In some aspects, the DCI 320 may also indicate a resource for transmitting the HARQ-ACK information 330 for the DL data signal 322. In the example illustrated in FIG. 3, the HARQ-ACK resource is in the slot 202 indexed S6.

As discussed above, the BS 105 may also configure the UE 115 with a configured grant for UL transmissions. A configured UL transmission is an unscheduled transmission, performed on the channel without a UL grant. A configured UL transmission may also be referred to as a grantless, grant-free, or autonomous transmission. In some examples, the UE may transmit a UL control information and/or UL data based on a configured grant. Additionally, configured-UL data may also be referred to as grantless UL data, grant-free UL data, unscheduled UL data, or autonomous UL (AUL) data. Additionally, a configured grant may also be referred to as a grant-free grant, unscheduled grant, or autonomous grant. The resources and other parameters used by the UE for a configured grant transmission may be provided by the BS in one or more of a RRC configurations or an activation DCI, without an explicit grant for each UL transmission.

For instance, the BS 105 may configure the UE 115 with an UL configured grant indicating a CG resource (e.g., a time-frequency resource) that repeats in time according to a certain periodicity (e.g., about 5 ms, 10 ms, 20 ms, 30 ms, 40 ms, 50 ms, etc.). As an example, the slot 202 indexed S6 may include one of the CG resources (shown as CG resource 360). Accordingly, the UE 115 may transmit a CG transmission 350 in the CG resource 360 without receiving a specific scheduling grant from the BS 105. The CG transmission 350 may include CG-UCI 352 and UL data 354 (e.g., information data or user data). The UL data 354 may be carried in a PUSCH. The CG-UCI 352 may also be transmitted in the PUSCH, for example, multiplexed with the UL data 354. The UE 115 may also apply HARQ techniques for the transmission of the UL data 354. Thus, the CG-UCI 352 may indicate HARQ information, such as a HARQ process ID, a NDI, and/or RV, associated with the UL data 354. The CG transmission 350 may be referred to as a CG-PUSCH transmission.

The CG transmission 350 may also include a demodulation reference signal (DMRS). The DMRS may include pilot symbols distributed across the frequency channel to enable the UE or the BS to perform channel estimation and demodulation for the decoding. The pilot symbols may be generated from a predetermined sequence with a certain pattern, and the remaining symbols may carry UL data. The DMRS allows a receiver (e.g., the BS 105) to determine a channel estimate for the channel, where the channel estimate may be used to recover the UL data.

In some aspects, the BS 105 may communicate with the UE 115 over a shared radio frequency band (e.g., in a shared spectrum or an unlicensed spectrum). To avoid collisions when communicating in a shared or an unlicensed spectrum, the UE 115 may perform LBT to contend for a COT in the shared channel. In an example, if channel is available (performance of the LBT results in a LBT pass and the UE 115 won the COT), the UE 115 may transmit an UL transmission (e.g., the CG transmission 350) during the COT. In some instances, the CG transmission 350 may occupy a portion of the COT, and the UE 115 may share the remaining time of the COT with the BS 105. To indicate that the BS 105 may share a remaining time in the COT for UL and/or DL transmissions, the UE 115 may include COT sharing information (e.g., a remaining duration in the COT) in the CG-UCI 352. If the channel is not available (performance of the LBT results in a LBT fail), the UE 115 may back off and perform the LBT procedure again at a later point in time.

As can be seen in FIG. 3, the HARQ-ACK information 330 and the UCI 340 that are scheduled for transmission in the slot 202 indexed S6 overlaps with the CG resource 360 configured for the CG transmission 350 including the CG-UCI 352 and the UL data 354. As an example, the CG resource 360 may occupy symbols 2-5 in the slot 202 indexed 6, and the scheduled the HARQ-ACK information 330 may be scheduled in a PUCCH resource 370 occupy symbols 3 of the slot 202 indexed S6 as shown by the reference numeral 302. In general, the scheduled resources for the HARQ-ACK information 330 and the UCI 340 may be at least partially overlapping with the CG resource 360. In some aspects, the UE 115 may be allowed to multiplex up to three separately encoded UCI in a PUSCH transmission, for example, as described in 3GPP Release 15. For instance, the UE 115 may separately encode the HARQ-ACK information 330, the UCI 340, and the CG-UCI 352. Each encoding may include segmentation, cyclic redundancy check (CRC) attachment, polar encoding, rate-match, and/or code block concatenation. Thus, the HARQ-ACK information 330, the UCI 340, and the CO-UCI 352 may be encoded into three separate code blocks. The UE 115 may multiplex the HARQ-ACK information 330, the UCI 340, and the CG-UCI 352 by mapping each code block to the CG resource 360. In some aspects, the UE 115 may map the CO-UCI 352 to a symbol (e.g., the symbol 206) after a DMRS symbol in the CG resource 360. The UE 115 may be configured with a set of rules or a resource mapping order for mapping other scheduled UCI onto the CG resource 360. In some aspects, the UE 115 may determine a number of REs for carrying the UCI 340 using similar mechanisms as for determining a number of REs for carrying the HARQ-ACK information 330. For instance, the BS 105 may configure the UE 115 with a beta offset, which is a variable that controls the coding rate used for sending bits (e.g., coded bits), for sending HARQ-ACK information 330 and another beta offset for sending the CG-UCI 352.

As discussed, the UCI 340 may include CSI part 1 and CSI part 2, and thus there are four UCI parts (e.g., CSI part 1, CSI part 2, HARQ-ACK information 330, and the CG-UCI 352) to be multiplexed, exceeding the maximum number of UCI parts of 3 allowed by the multiplexing rule discussed above. In some aspects, the BS 105 may provide the UE 115 with an RRC configuration indicating whether the UE 115 may multiplex CG-UCI and HARQ-ACK. When the UE 115 is configured for such multiplexing and a PUCCH (e.g., for carrying HARQ-ACK) overlaps with a CG-PUSCH(s) within a PUCCH group (e.g., for CSI part 1, CSI part 2), the UE 115 may jointly encode the HARQ-ACK and CG-UCI. The jointly-encoded HARQ-ACK and CG-UCI may be treated as the same as a code block of HARQ-ACK type. In this regard, the UE 115 may apply the same HARQ-ACK rate matching rule to send the jointly-encoded HARQ-ACK and CG-UCI. Accordingly, the UE 115 may multiplex three encoded UCI parts, encoded CSI part 1, encoded CSI part 2, and the jointly-encoded HARQ-ACK and CG-UCI in the CG transmission 350. When the UE 115 is not configured to multiplex HARQ-ACK with CG-UCI and the a PUCCH (e.g., for carrying HARQ-ACK) overlaps with a CG-PUSCH(s) within a PUCCH group, the UE 115 may skip or drop the CG transmission 350. For instance, the UE 115 may refrain from queuing the CG transmission 350 in a transmission buffer queue or removing the CG transmission 350 from the transmission queue.

In some aspects, the BS 105 may assign a two-level priority for an UL channel or UL transmission, for example, for URLLC. In other words, the BS 105 may assign an UL channel or UL transmission with a high traffic priority or a low traffic priority. In some aspects, the BS 105 may assign a low-priority for periodic-CSI (P-CSI), semi-persistent-CSI (SP-CSI), periodic-sounding reference signal (P-SRS), and/or semi-persistent-SRS (SP-SRS). The BS 105 may assign a high-priority or a low-priority for a dynamically scheduled HARQ-PUCCH via DCI signaling. The BS 105 may assign a high-priority or a low-priority for a SPS PDSCH via an RRC configuration. The BS 105 may assign a high-priority or a low-priority for a CG-PUSCH via an RRC configuration.

In some aspects, the HARQ-ACK information 330, the UCI 340, and the CG-UCI 352 may be of different priorities. For instance, the UCI 340 may include CSI part 1 and/or CSI part 2, and thus may be associated with a low-priority. The BS 105 may assign a low-priority for the HARQ-ACK information 330. The BS 105 may assign a high-priority for the CG resource 360, and thus the CG-UCI 352 may be of a high-priority. As such, there is an overlap between UCI and CG-UCI of different priorities in the slot 202 indexed S6. However, the multiplexing rules discussed above does not handle multiplexing UCI and CG-UCI of different priorities in a CG-PUSCH transmission.

Accordingly, the present disclosure provides techniques for multiplexing UCI and CG-UCI of different priorities in a CG-PUSCH transmission. In an aspect, a UE may multiplex scheduled UCIs, CG-UCIs, and CG UL data of the different priorities by determining or selecting a number of low-priority UCI bits for multiplexing with the high-priority UCI and/or CG-UCI. The determining may be based on a predefined or configured threshold number of bits. Further, the UE may be configured to multiplex the high-priority and low-priority communications based on determining whether a multiplexing configuration for HARQ-ACK information and CG-UCI is enabled when HARQ-ACK is present.

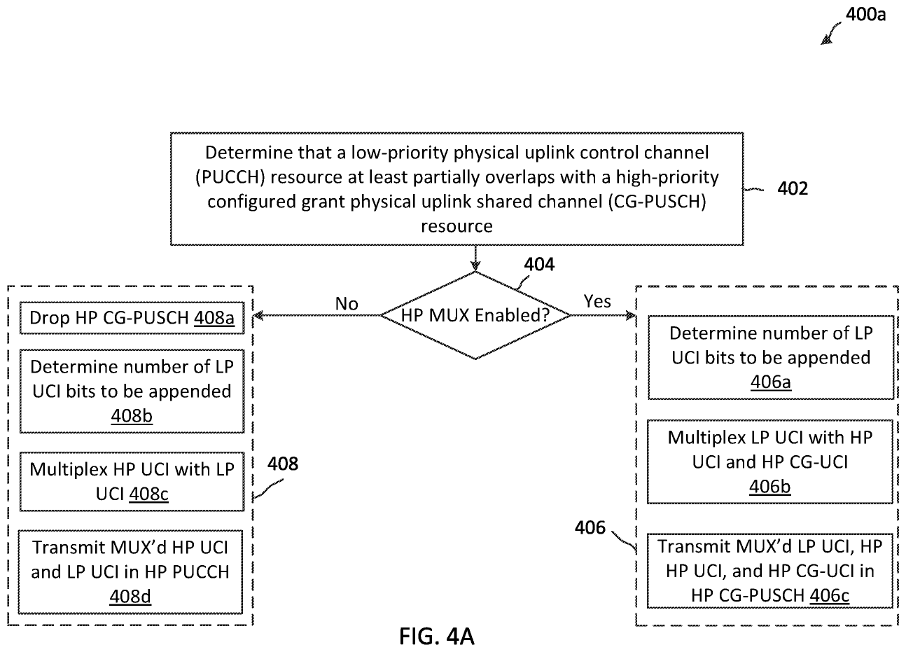

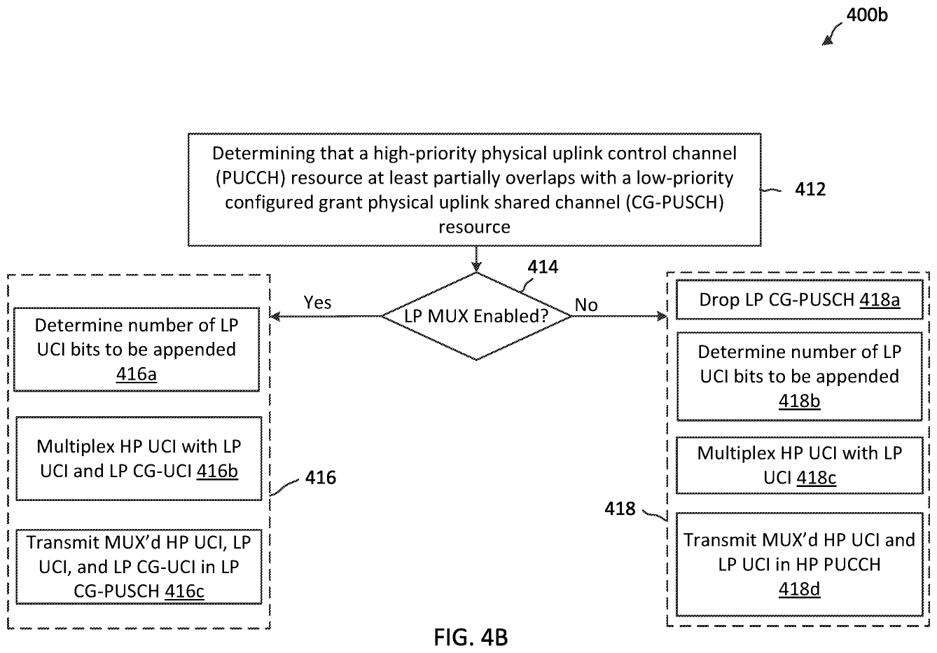

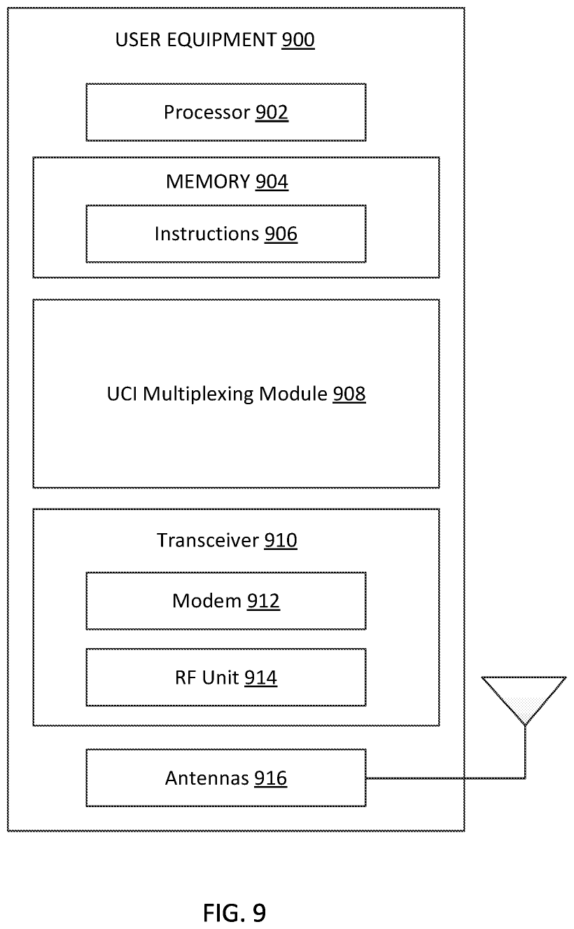

FIGS. 4A and 4B are flow diagrams illustrating mechanisms for multiplexing CG-PUSCH transmissions and UCI transmissions associated with different priorities. The schemes or methods 400 illustrated in FIGS. 4A and 4B may be employed by a wireless communication device, such as a UE 115 in the network 100 for UL communications. The UE may utilize one or more components of the UE 900 described below with respect to FIG. 9, such as the processor 902, the memory 904, the UCI multiplexing module 908, the transceiver 910, the modem 912, and the one or more antennas 916, to execute the steps of the methods 400. In particular, a UE may handle overlapping CG-PUSCH and UCI communications by multiplexing UCI having a first priority with at least one of a CG-PUSCH or a UCI having a different second priority. In this regard, the UE may be configured to receive and/or transmit communications having different priorities, where the CG communications and the scheduled communications are associated with different priorities. Multiplexing the overlapping communications may include appending one communication, such as UCI, to another communication, such as CG-UCI, for example. Further, UE may determine the number of bits for multiplexing based on a configured number of bits, or threshold number of bits.

In the scheme 400a shown in FIG. 4A, the first priority is a low-priority, and the second priority is a high-priority. In other words, the wireless communication device, which may be a UE, is configured to transmit the high-priority communications using a CG communication scheme, and to transmit the low-priority communications using a scheduled communication scheme. The high-priority communications may include CG-UCI and data. The low-priority communications may include UCI, including HARQ-ACK information and CSI. The CSI may be a CSI part 1, in some aspects. The high-priority communications may further include HARQ-ACK information, such that the wireless communication device is configured to transmit HARQ-ACK information for both low-priority and high-priority communications.

In action 402, the UE determines that a low-priority physical uplink control channel (PUCCH) resource at least partially overlaps with a high-priority configured grant physical uplink shared channel (CG-PUSCH) resource. The PUCCH resource and the CG-PUSCH resource may overlap as shown in the slot 302 of FIG. 3, for example.

In action 404, the UE determines whether multiplexing is enabled for high-priority CG-UCI and HARQ-ACK when high-priority HARQ-ACK is present. For the purposes of the present disclosure, a communication may be referred to as “present” if it is scheduled for communication in a time period, such as the overlapping time period determined in action 402. Multiplexing may be enabled via a multiplexing configuration transmitted by a BS in the network, in some aspects. The multiplexing configuration may include a parameter indicating whether high-priority CG-UCI and high-priority HARQ-ACK may be multiplexed for transmission to the BS. In some aspects, the multiplexing configuration may include a CG-UCI/HARQ-ACK multiplexing indicator when the high-priority CG-UCI and high-priority HARQ-ACK multiplexing is allowed, and may exclude the CG-UCI/HARQ-ACK multiplexing indicator otherwise. The multiplexing configuration may also indicate the number of low-priority UCI bits that can be multiplexed with high-priority UCI or high-priority CG-PUSCH. For example, the multiplexing configuration may indicate a number of bits allocated for multiplexed low-priority UCI or CG-UCI. The number of bits may be a fixed number of bits, or may be a variable number of bits having an upper bound. A fixed number of bits allocated for low-priority UCI, which may include low-priority HARQ-ACK and/or CSI part 1, may be represented by X bits. In this regard, the multiplex configuration may indicate an X bit value associated with a fixed number of bits. For a fixed number of bits, the UE may be configured to add padding bits to the end of the UCI bits if the number of multiplexed UCI bits is less than X bits.

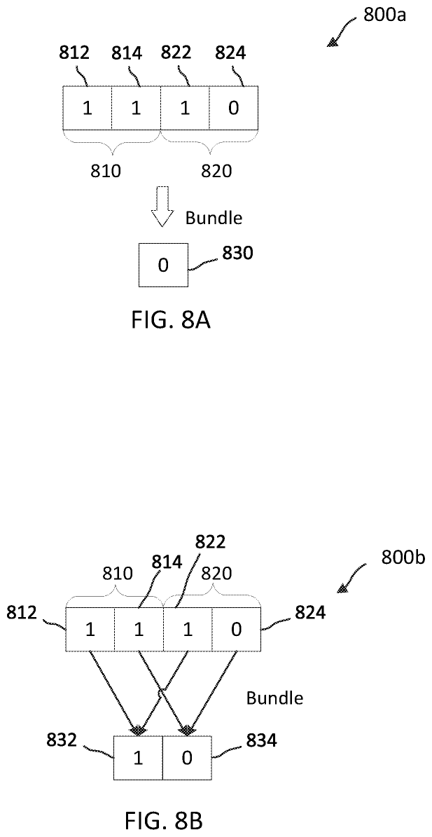

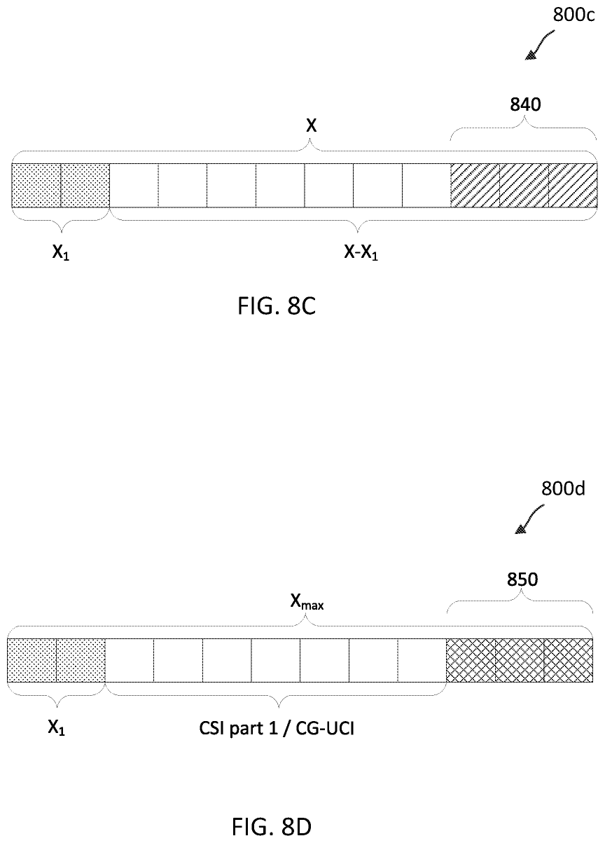

In some instances, the number of low-priority UCI bits scheduled for transmission may be greater than the fixed number of bits. In such instances, the UE may be configured to compress or reduce the number of bits of low-priority UCI for multiplexing, which may include bundling, truncating, or otherwise compressing the number of UCI bits to satisfy the number of bits allocated for low-priority UCI (e.g., the fixed number of bits or the upper bound). Compressing, bundling, and truncating the UCI bits for multiplexing is further described below with respect to FIGS. 8A-8D. A variable, upper-bounded number of bits allocated for low-priority UCI may be represented by Xₘₐₓ bits. The Xₘₐₓ bit value may be indicated in the multiplexing configuration such that the UE can multiplex a variable number of low-priority UCI bits up to an upper bound number of bits. With a variable number of bits for low-priority UCI configured, if the low-priority UCI bits that would be multiplexed is less than the upper bound Xₘₐₓ, the actual low-priority UCI bits may be multiplexed (e.g., without bundling or truncating). In some aspects, the number of bits (X or Xₘₐₓ) is configured by radio resource control (RRC) signaling. In other aspects, the number of bits (X or Xₘₐₓ) is hardcoded in the UE as part of the wireless communication specification.

In action 406, in response to determining that multiplexing is enabled for high-priority CG communications and HARQ-ACK when high-priority HARQ-ACK is present, the UE performs multiplexing and transmission of the low-priority UCI and the high-priority CG communication. In some aspects, the action 406 includes determining a number of low-priority UCI bits to be appended or multiplexed to the CG communication at action 406a. As explained above, determining the number of low-priority UCI bits for multiplexing at action 406a may include determining the number of low-priority UCI bits based on a fixed configured number of bits or a variable configured number of bits (with an upper bound). The configured number of bits may be referred to as a threshold number of bits. In some aspects, determining the number of low-priority UCI bits includes adding padding bits when the number of low-priority UCI bits is less than a fixed threshold of bits allocated for low-priority UCI (X). In other aspects, determining the number of low-priority UCI bits includes determining whether an actual number of low-priority UCI bits equals or falls below an upper bound (Xₘₐₓ), and determining whether to transmit the actual, non-truncated low-priority UCI bits based on the determining. Further, determining the number of low-priority UCI bits for multiplexing with the CG communication may include bundling, truncating, or compressing all or a portion of the low-priority UCI bits. In some aspects, the low-priority UCI may include a low-priority HARQ-ACK and a CSI part 1. The UE may be configured to bundle the low-priority HARQ-ACK to one, two, three, or any other suitable number of bits. The UE may be further configured to truncate the CSI part 1 bits based on the bundled number of HARQ-ACK bits and the preconfigured threshold number of bits.

In some aspects, the action 406 further includes multiplexing the low-priority UCI with the high-priority HARQ-ACK and the high-priority CG-UCI at action 406b. Multiplexing the low-priority UCI and the high-priority UCI and CG-UCI in action 406b may include appending and encoding the low-priority UCI with the high-priority UCI and CG-UCI according to a certain order. In this regard, the UE may append high-priority UCI, such as a high-priority HARQ-ACK to the high-priority CG-UCI. The UE may also bundle and/or truncate low-priority UCI bits, and append the bundled and/or truncated low-priority UCI bits to the high-priority CG-UCI and high-priority UCI. The low-priority UCI may include a low-priority HARQ-ACK and/or low-priority CSI, such as a CSI part 1. The UE may then encode the appended low-priority UCI bits, high-priority CG-UCI and high-priority UCI to generate an encoded block. The UE then multiplexes the encoded block for transmission.

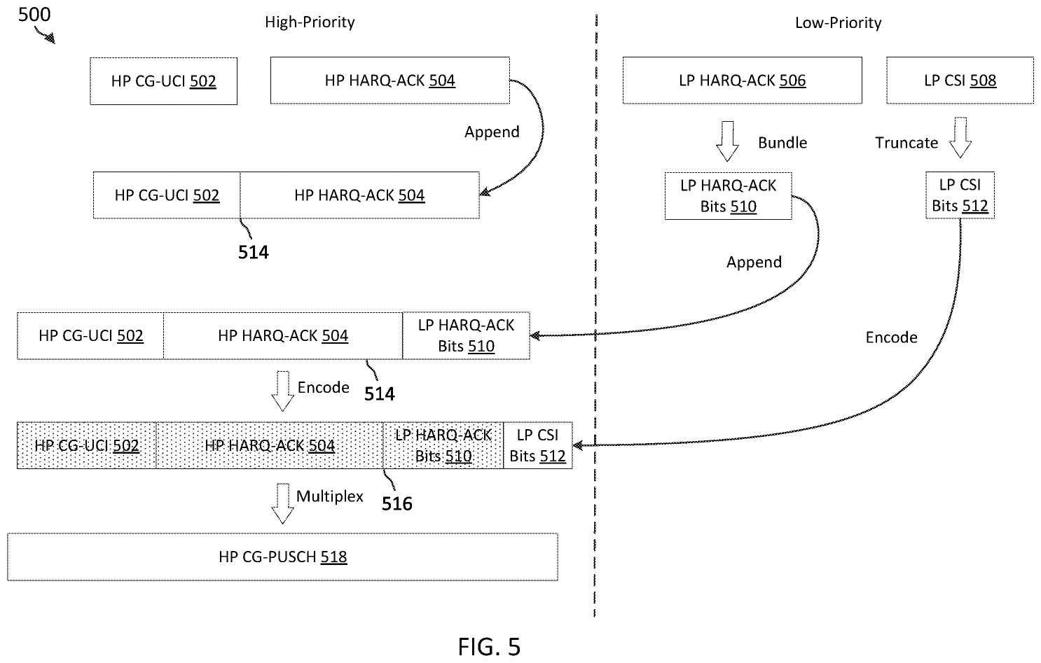

In some aspects, the action 406 further includes transmitting the multiplexed low-priority UCI, high-priority HARQ-ACK, and high-priority CG-UCI to the BS at action 406c. Action 406c may include the UE transmitting the appended and encoded low-priority UCI, the high-priority UCI, and CG communications in a high-priority CG-PUSCH. The steps and actions of block 406 (e.g., the order of appending and/or encoding) will be further described below with respect to FIG. 5.

In action 408, in response to determining that the UE is not configured to multiplex high-priority CG-UCI with HARQ-ACK when high-priority HARQ-ACK is present, the UE performs a different multiplexing and transmission procedure than what is shown in action 406. In particular, the UE refrains from transmitting the high-priority CG-PUSCH communication using a high-priority CG-PUSCH resource in the overlapping period, and instead multiplexes and transmits the high-priority UCI and the low-priority UCI in a high-priority PUCCH.

In some aspects, action 408 includes dropping or refraining from transmitting a CG-PUSCH communication in action 408a. In some instances, the high-priority CG-PUSCH transmission may be held at a transmit data buffer ready for transmission. The refraining from transmitting the high-priority CG-PUSCH communication may include discarding, or flushing the high-priority CG-PUSCH communication data from the transmit data buffer.

In some aspects, action 408 includes determining the number of low-priority UCI bits to be appended at action 408b, as similarly described with respect to action 406a. In this regard, determining the number of low-priority UCI bits may include compressing, bundling, or truncating the low-priority UCI bits based on a preconfigured number of bits or threshold number of bits (e.g., X or Xₘₐₓ).

In some aspects, action 408 further includes multiplexing, in response to determining the number of low-priority UCI bits to multiplex, the high-priority UCI with the low-priority UCI based on the determined number of bits at action 408c. Multiplexing the high-priority UCI and low-priority UCI may include appending the high-priority UCI and the low-priority UCI, and jointly encoding the high-priority UCI and low-priority UCI. The UE may multiplex of the high-priority UCI and the low-priority UCI may be performed by the UE according to a specific order. In this regard, the UE may bundle and/or truncate low-priority UCI bits, and append the bundled and/or truncated low-priority UCI bits to high-priority UCI, which may include a high-priority HARQ-ACK. The low-priority UCI may include a low-priority HARQ-ACK and a low-priority CSI part 1. The UE may then encode the appended low-priority UCI bits and high-priority UCI to generate an encoded block. The UE then multiplexes the encoded block for transmission.

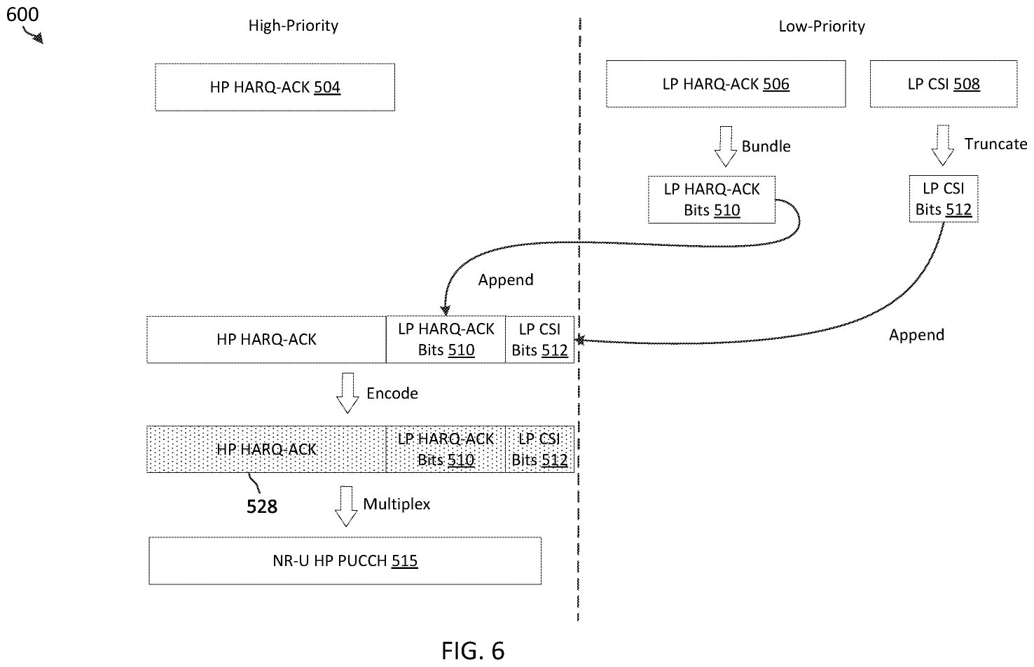

In some aspects, action 408 further includes transmitting the low-priority UCI and high-priority UCI to the BS in a high-priority PUCCH resource at action 408d. The steps and actions of block 408 will be further described below with respect to FIG. 6.

In the scheme 400b shown in FIG. 4B, the first priority is a high-priority, and the second priority is a low-priority. In other words, the wireless communication device, which may be a UE, is configured to transmit the low-priority communications using a CG communication scheme, and to transmit the high-priority communications using a scheduled communication scheme. The low-priority communications may include CG-UCI and data. The high-priority communications may include UCI, including HARQ-ACK information and CSI. The CSI may be a CSI part 1, in some aspects. The low-priority communications may further include HARQ-ACK information, such that the wireless communication device is configured to transmit HARQ-ACK information for both low-priority and high-priority communications.

In action 412, the UE determines that a high-priority physical uplink control channel (PUCCH) resource at least partially overlaps with a low-priority configured grant physical uplink shared channel (CG-PUSCH) resource. The PUCCH resource and the CG-PUSCH resource may overlap as shown in the slot 302 of FIG. 3, for example.

In action 414, the UE determines whether multiplexing is enabled for low-priority CG-UCI and HARQ-ACK when low-priority HARQ-ACK is present. Multiplexing may be enabled via a multiplexing configuration transmitted by a BS in the network, in some aspects. The multiplexing configuration may include a parameter indicating whether low-priority CG-UCI and low-priority HARQ-ACK may be multiplexed for transmission to the BS. In some aspects, the multiplexing configuration may include a CG-UCI/HARQ-ACK multiplexing indicator when the low-priority CG-UCI and low-priority HARQ-ACK multiplexing is allowed, and may exclude the CG-UCI/HARQ-ACK multiplexing indicator otherwise. The multiplexing configuration may also include parameters indicating the number of low-priority UCI bits that can be multiplexed with high-priority UCI or low-priority CG-PUSCH. For example, the multiplexing configuration may indicate a number of bits allocated for multiplexed low-priority UCI or CG-UCI. The number of bits may be a fixed number of bits, or may be a variable number of bits. A fixed number of bits allocated for low-priority UCI, which may include low-priority HARQ-ACK and/or CSI part 1, may be represented by X bits. In this regard, the multiplex configuration may indicate an X bit value associated with a fixed number of bits. For a fixed number of bits, the UE may be configured to add padding bits if the number of multiplexed UCI bits is less than X bits. The UE may be configured to compress or reduce the number of bits of low-priority UCI for multiplexing, which may include bundling, truncating, or otherwise compressing the number of UCI bits. Further, the UE may be configured to compress the low-priority CG-UCI bits, bundling, and truncating the UCI bits for multiplexing is further described below with respect to FIG. 8. A variable, upper-bounded number of bits allocated for low-priority UCI may be represented by Xₘₐₓ bits. The Xₘₐₓ bit value may be indicated in the multiplexing configuration such that the UE can multiplex a variable number of low-priority UCI bits up to an upper bound number of bits. With a variable number of bits for low-priority UCI configured, if the low-priority UCI and/or CG-UCI bits that would be multiplexed is less than the upper bound Xₘₐₓ, the actual low-priority UCI bits may be multiplexed (e.g., without bundling or truncating). In some aspects, the number of bits (X or Xₘₐₓ) is configured by a radio resource control (RRC) communication. In other aspects, the number of bits (X or Xₘₐₓ) is hardcoded in the UE as part of the wireless communication specification.

In action 416, in response to determining that multiplexing is enabled for low-priority CG communications and HARQ-ACK when low-priority HARQ-ACK is present, the UE performs multiplexing and transmission of the high-priority UCI and the low-priority CG communication.

In some aspects, action 416 includes determining a number of low-priority UCI bits and/or low-priority CG-UCI bits to be appended or multiplexed to the high-priority UCI at action 416a. As explained above, determining the number of low-priority UCI bits for multiplexing may include determining the number of low-priority UCI bits based on a fixed configured number of bits or a variable configured number of bits. In some aspects, determining the number of low-priority UCI bits includes adding padding bits when the number of low-priority UCI bits is less than a fixed threshold (X) of bits allocated for low-priority UCI. In other aspects, determining the number of low-priority UCI bits includes determining whether an actual number of low-priority UCI bits equals or falls below an upper bound (Xₘₐₓ), and determining whether to transmit the actual low-priority UCI bits based on the determining. Further, determining the number of low-priority UCI bits and/or low-priority CG-UCI bits for multiplexing with the high-priority UCI may include bundling, truncating, or compressing all or a portion of the low-priority UCI bits and/or CG-UCI bits. For example, the low-priority UCI may include a low-priority HARQ-ACK and a CSI part 1. The UE may be configured to bundle the low-priority UCI and low-priority CG-UCI to one, two, three, or any other suitable number of bits. The UE may be further configured to truncate the CSI part 1 bits to one, two, three, or any other suitable number of bits.

In some aspects, action 416 further includes multiplexing the high-priority UCI bits with the low-priority UCI and the low-priority CG-UCI at action 416b. Multiplexing the high-priority UCI with the low-priority CG-UCI and/or the low-priority UCI may further include appending and encoding the high-priority UCI, the low-priority CG-UCI, and the low-priority UCI.

The UE may multiplex the high-priority UCI bits with the low-priority UCI and the low-priority CG-UCI according to a certain order. In this regard, the UE may append low-priority UCI, such as a low-priority HARQ-ACK to the low-priority CG-UCI. The UE may also bundle and/or truncate low-priority UCI bits, and append the high-priority UCI (e.g., high-priority HARQ-ACK) to the bundled and/or truncated low-priority UCI bits. The low-priority UCI may include a low-priority HARQ-ACK and/or low-priority CSI, such as a CSI part 1. The UE may then encode the appended low-priority UCI bits, low-priority CG-UCI and high-priority UCI to generate an encoded block. The UE then multiplexes the encoded block with the low-priority CG uplink data for transmission.

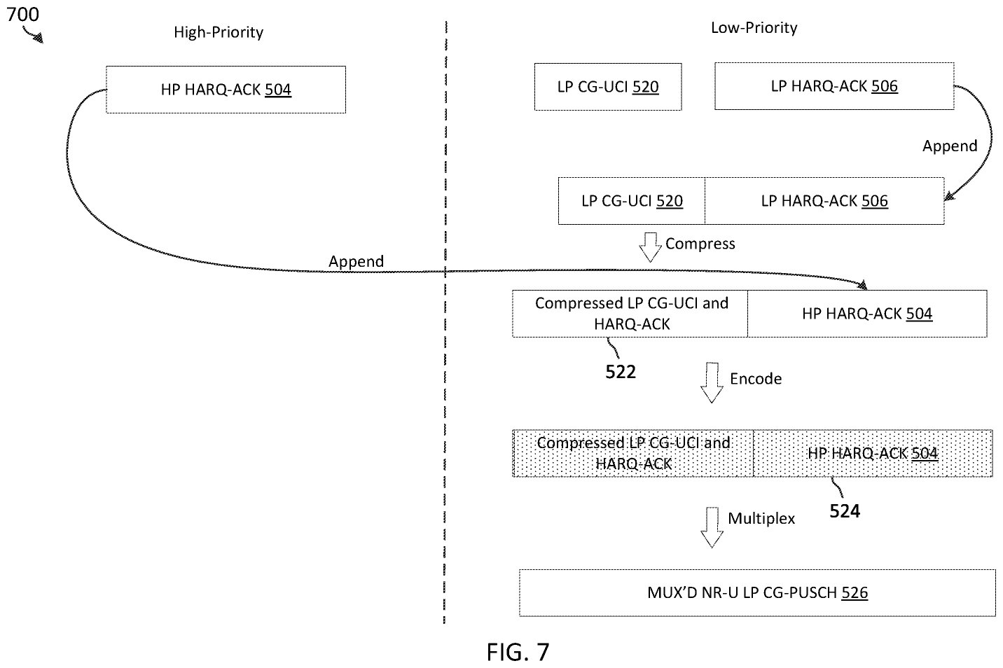

In some aspects, action 416 further includes transmitting the multiplexed high-priority UCI, low-priority UCI, and low-priority CG-UCI, and low-priority CG uplink data to the BS in a low-priority CG-PUSCH at action 416c. The steps and actions of block 416 will be further described below with respect to FIG. 7. In action 418, in response to determining that the UE is not configured to multiplex CG-UCI with HARQ-ACK when low-priority HARQ-ACK is present, the UE performs a different multiplexing and transmission procedure than what is shown in action 416. In particular, the UE drops the low-priority CG-PUSCH communication, and instead multiplexes and transmits the high-priority UCI and the low-priority UCI in a high-priority PUCCH. Specifically, the UE determines the number of low-priority UCI bits to be appended, as similarly described with respect to action 416. In this regard, determining the number of low-priority UCI bits may include compressing, bundling, or truncating the low-priority UCI bits based on a preconfigured number of bits or threshold number of bits (e.g., X or)(max). In response to determining the number of low-priority UCI bits to multiplex, the UE multiplexes the high-priority UCI (e.g., high-priority HARQ-ACK) with the low-priority UCI (e.g., low-priority HARQ-ACK) based on the determined number of bits. Multiplexing the high-priority UCI and low-priority UCI may include appending the high-priority UCI and the low-priority UCI, and jointly encoding the high-priority UCI and low-priority UCI. The UE may then transmit the low-priority UCI and high-priority UCI to the BS in a high-priority PUCCH resource. At least some of the steps and actions of block 418 will be further described below with respect to FIG. 6.

FIGS. 5-7 illustrate various schemes for multiplexing UCI and CG communications associated with different priorities in a shared frequency band. The schemes 500, 600, and 700, may correspond to the actions of the methods 400a and 400b. For example, the scheme 500 shown in FIG. 5 may correspond to action 406 of the scheme 400a, the scheme 600 shown in FIG. 6 may correspond to action 408 of the scheme 400a and action 418 of the scheme 400b, and the scheme 700 shown in FIG. 7 may correspond to action 416 of the scheme 400b. The schemes 500, 600, and 700 illustrated in FIGS. 5, 6, and 7 may be employed by a wireless communication device, such as a UE 115 in the network 100 for UL communications. The UE may utilize one or more components of the UE 900 described below with respect to FIG. 9, such as the processor 902, the memory 904, the UCI multiplexing module 908, the transceiver 910, the modem 912, and the one or more antennas 916, to execute the steps of the methods 500, 600, 700. In particular, a UE may handle overlapping CG-PUSCH and UCI communications by multiplexing UCI having a first priority with at least one of a CG-PUSCH or a UCI having a different second priority. In this regard, the UE may be configured to receive and/or transmit communications having different priorities, where the CG communications and the scheduled communications are associated with different priorities. Multiplexing the overlapping communications may include appending one transmission, such as UCI, to another communication, such as CG-UCI, for example. However, the number of bits available for appending to a communication may be less than the number of bits contained in the appended communications.

Referring to FIG. 5, the scheme 500 may be used by a UE when the UE is configured to multiplex high-priority CG-UCI with high-priority HARQ-ACK when high-priority HARQ-ACK is present. In the scheme 500, the UE may have scheduled high-priority CG-UCI 502 and high-priority HARQ-ACK 504 in a time period. The UE may also have scheduled low-priority UCI for the time period. The low-priority UCI includes low-priority HARQ-ACK 506 and low-priority CSI 508. The low-priority CSI 508 may include CSI part 1. The multiplexing configuration may be hardcoded into the wireless communication specification, or may be configured by a BS via RRC signaling. When the multiplexing is configured, the high-priority HARQ-ACK 504 can be appended to the high-priority CG-UCI 502. In some aspects, appending the high-priority HARQ-ACK 504 to the high-priority CG-UCI 502 includes appending all of the high-priority HARQ-ACK 504 bits to the high-priority CG-UCI. The appended high-priority CG-UCI 502 and high-priority HARQ-ACK 504 may be referred to as a block, such as a first block.

The UE is also configured to determine a number of bits of the low-priority UCI, including the low-priority HARQ-ACK 506 and the low-priority CSI 508, for appending to the first block. The number of bits the UE determines may be a fixed number of bits or a variable number of bits having an upper bound. The number of low-priority UCI bits that can be multiplexed with CG communications may be hardcoded in the wireless communication specification, or may be configured by RRC signaling. In some aspects, if the low-priority UCI bits that would be multiplexed is less than the fixed threshold (X) number of bits, padding bits may be added to the end of the UCI. In another aspect, the number of low-priority UCI bits that can be multiplexed with CG communications may be variable with an upper bound number of bits (Xₘₐₓ). The variable threshold number of bits Xₘₐₓ may be hardcoded in the wireless communication specification or configured by RRC signaling. In some aspects, if the low-priority UCI bits that would be multiplexed is less than the upper bound Xₘₐₓ, the actual low-priority UCI bits may be multiplexed such that the UCI is not compressed, bundled, truncated, or otherwise reduced.

FIG. 5 shows that the low-priority HARQ-ACK 506 is bundled such that a smaller number of low-priority HARQ-ACK bits 510 is selected. Similarly, the low-priority CSI 508 is truncated by the UE such that a smaller number of low-priority CSI bits 512 is selected. The bundling, truncating, and other compression schemes are illustrated below with respect to FIG. 8.

The UE appends the low-priority HARQ-ACK bits 510 to the first block 514, which includes the high-priority CG-UCI 502 and the high-priority HARQ-ACK 504. The UE then encodes the first block 514, which now includes the appended low-priority HARQ-ACK bits 510, to generate an encoded first block 516. In some aspects, the encoding may include processing the first block 516 by an LDPC encoder, performing code block segmentation, channel encoding, rate-matching, and/or modulation according to a certain modulation scheme. The UE separately encodes the low-priority CSI bits 512 and appends the encoded LP CSI bits 512 to the encoded first block 516. The encoding of the low-priority CSI bits 512 may include similar encoding operations described above for the first block 516. In some aspects, the encoded first block 516 and the appended low-priority CSI bits 512 may be referred to as a second block. The UE then multiplexes and transmits the high-priority CG-UCI 502, the high-priority HARQ-ACK 504, the low-priority HARQ-ACK bits 510, and the low-priority CSI bits 512 along with high-priority CG uplink data in a high-priority CG-PUSCH resource 518. In some aspects, the multiplexing may further include mapping modulation symbols for the encode first block 516, the encoded low-priority CSI bits 512, and the high-priority CG uplink data to subcarriers of the CG-PUSCH resource 518 according to a certain order. Accordingly, when scheduled communications of different priorities overlap in a time period, the UE may multiplex high-priority CG-UCI and high-priority HARQ-ACK with a low-priority UCI by selecting a number of bits according to a low-priority UCI bit selection or determination configuration.

In some aspects, the low-priority HARQ-ACK may not be present. Accordingly, the total number of bits allocated for low-priority UCI (e.g., X, Xₘₐₓ) may be used for the low-priority CSI. In other aspects, the low-priority CSI may not be present. In some aspects, the number of low-priority HARQ-ACK bits 510 determined by the UE may be referred to as X1. Thus, if there are X bits allocated for low-priority UCI, the UE may allocate X1 bits of the X bits for the low-priority HARQ-ACK 506, and X−X1 bits for the low-priority CSI 508. Accordingly, the UE may truncate the low-priority CSI 508 by selecting the first (X−X1) bits of the low-priority CSI 508.

Referring to FIG. 6, the scheme 600 may be used by a UE when the UE is not configured to multiplex CG-UCI with HARQ-ACK when high-priority HARQ-ACK is present, as in action 408 shown in FIG. 4A. Alternatively, the scheme 600 may be used by a UE when the UE is not configured to multiplex CG-UCI with HARQ-ACK when low-priority HARQ-ACK is present, as in action 418 shown in FIG. 4B. In the scheme 600, the UE may have scheduled high-priority HARQ-ACK 504 in a time period. The UE may also have scheduled low-priority UCI for the time period. The low-priority UCI includes low-priority HARQ-ACK 506 and low-priority CSI 508. The low-priority CSI 508 may include CSI part 1. Although multiplexing CG-UCI with HARQ-ACK is not enabled in the scheme 600, the UE is configured to multiplex the low-priority UCI with high-priority UCI (e.g., high-priority HARQ-ACK 504). The multiplexing configuration may be hardcoded into the wireless communication specification, or may be configured by a BS via RRC signaling. According to the multiplexing scheme 600, the UE appends a bundled low-priority HARQ-ACK 506 and a truncated low-priority CSI 508 to the high-priority HARQ-ACK 504.

The UE determines a number of low-priority UCI bits for appending to the high-priority HARQ-ACK based on a configured number of bits. The number of bits may be a fixed configured number of bits or a variable configured number of bits having an upper bound. The number of low-priority UCI bits that can be multiplexed with CG communications may be hardcoded in the wireless communication specification, or may be configured by RRC signaling. In some aspects, if the low-priority UCI bits that would be multiplexed is less than the fixed threshold (X) number of bits, padding bits may be added to the end of the UCI. In another aspect, the number of low-priority UCI bits that can be multiplexed with CG communications may be variable with an upper bound number of bits (Xₘₐₓ). The variable threshold number of bits Xₘₐₓ may be hardcoded in the wireless communication specification or configured by RRC signaling. In some aspects, if the low-priority UCI bits that would be multiplexed is less than the upper bound Xₘₐₓ, the actual low-priority UCI bits may be multiplexed such that the UCI is not compressed, bundled, truncated, or otherwise reduced.

FIG. 6 shows that the low-priority HARQ-ACK 506 is bundled such that a smaller number of low-priority HARQ-ACK bits 510 is selected. Similarly, the low-priority CSI 508 is truncated by the UE such that a smaller number of low-priority CSI bits 512 is selected. The bundling, truncating, and other compression schemes are illustrated below with respect to FIG. 8.

The UE appends the low-priority HARQ-ACK bits 510 to the high-priority HARQ-ACK 504, and jointly encodes the high-priority HARQ-ACK 504 and the appended low-priority HARQ-ACK bits 510, and low-priority CSI bits 512 to generate an encoded first block 528. In some aspects, the encoding may include processing the high-priority HARQ-ACK 504 and the appended low-priority HARQ-ACK bits 510 and low-priority CSI bits 512 by an LDPC encoder, performing code block segmentation, channel encoding, rate-matching, and/or modulation according to a certain modulation scheme. The UE then multiplexes and transmits the high-priority HARQ-ACK 504, the low-priority HARQ-ACK bits 510, and the low-priority CSI bits 512 in a high-priority PUCCH resource 515. Multiplexing the high-priority HARQ-ACK 504, the low-priority HARQ-ACK bits 510, and the low-priority CSI bits 512 may include mapping modulation symbols for the encoded first block 528 to subcarriers of the PUCCH resource according to a certain order. Accordingly, when scheduled communications of different priorities overlap in a time period, the UE may multiplex high-priority HARQ-ACK with low-priority UCI by selecting a number of bits according to a low-priority UCI bit selection or determination configuration.

In some aspects, the low-priority HARQ-ACK may not be present. Accordingly, the total number of bits allocated for low-priority UCI (e.g., X, Xₘₐₓ) may be used for the low-priority CSI 508. In other aspects, the low-priority CSI 508 may not be present. In some aspects, the number of low-priority HARQ-ACK bits 510 determined by the UE may be referred to as X1. Thus, if there are X bits allocated for low-priority UCI, the UE may allocate X1 bits of the X bits for the bundled low-priority HARQ-ACK bits 510, and (X−X1) bits for the low-priority CSI 508. Accordingly, the UE may truncate the low-priority CSI 508 by selecting the first (X−X1) bits of the low-priority CSI 508.

Referring to FIG. 7, the scheme 700 may be used by a UE when the UE is configured to multiplex CG-UCI with HARQ-ACK when a low-priority HARQ-ACK is present. In the scheme 700, the UE may have scheduled low-priority CG-UCI 520 and low-priority HARQ-ACK 506 in a time period. The UE may also have scheduled high-priority HARQ-ACK 504 for the time period. The multiplexing configuration may be hardcoded into the wireless communication specification, or may be configured by a BS via RRC signaling. When the multiplexing is configured, the low-priority HARQ-ACK 506 can be appended to the low-priority CG-UCI 520. In some aspects, appending the low-priority HARQ-ACK 506 to the low-priority CG-UCI 520 includes appending all low-priority HARQ-ACK 506 bits or LP HARQ-ACK 506 bits with bundling to the low-priority CG-UCI 520, and compressing the appended low-priority CG-UCI 520 and/or low-priority HARQ-ACK 506 to generate a first block 522. In some aspects, only the low-priority CG-UCI is compressed. For example, the low-priority CG-UCI may be compressed by determining a total number of bits allocated for low-priority UCI and CG-UCI 520 and subtracting the low-priority HARQ-ACK 506 bits from the total number of bits to determine a number of remaining bits for the low-priority CG-UCI 520. The UE may then select and transmit the first (X−X1) or (Xₘₐₓ−X1) bits of the low-priority CG-UCI. The selected bits of the low-priority CG-UCI 520 may include, for example, HARQ process ID, RV, and/or NDI.

The UE appends the high-priority HARQ-ACK 504 to the first block 522, which includes the compressed low-priority CG-UCI 520 and the low-priority HARQ-ACK 506. The UE then encodes the first block 522, which now includes the appended high-priority HARQ-ACK 504, to generate an encoded first block 524. In some aspects, the encoding may include processing the first block 522 by an LDPC encoder, performing code block segmentation, channel encoding, rate-matching, and/or modulation according to a certain modulation scheme. The UE then multiplexes and transmits the encoded first block 524, which includes the compressed low-priority CG-UCI 520 and low-priority HARQ-ACK 506, and the high-priority HARQ-ACK 506 along with the low-priority CG uplink data in a low-priority CG-PUSCH resource 526. In some aspects, the multiplexing may further include mapping modulation symbols for the encoded first block 516, the encoded LP CSI bits 512, and the high-priority CG uplink data to subcarriers of the CG-PUSCH resource 518 according to a certain order. Accordingly, when scheduled communications of different priorities overlap in a time period, the UE may multiplex low-priority CG-UCI and low-priority HARQ-ACK with high-priority UCI by selecting a number of bits according to a low-priority UCI and/or low-priority CG-UCI bit selection or determination configuration.

In some aspects, the low-priority HARQ-ACK may not be present. Accordingly, the total number of bits allocated for low-priority UCI and low-priority CG-UCI (e.g., X,)(max) may be used for the low-priority CG-UCI 520. In some aspects, the number of bundled low-priority HARQ-ACK bits 510 determined by the UE may be referred to as X1. Thus, if there are X bits allocated for low-priority UCI, the UE may allocate X1 bits of the X bits for the low-priority HARQ-ACK 506, and (X−X1) bits for the low-priority CG-UCI 520. Accordingly, the UE may compress the low-priority CG-UCI 520 by selecting the first (X−X1) bits of the low-priority CG-UCI 520.

FIGS. 8A-8D are diagrammatic views of compression schemes (including bundling and/or truncation) for reducing or modifying the size of UCI and/or CG-UCI communications, according to aspects of the present disclosure. The schemes 800 illustrated in FIGS. 8A-8D may be employed by a wireless communication device, such as a UE 115 in the network 100 for UL communications. In particular, a UE may reduce or modify the size of a UCI and/or CG-UCI communication for multiplexing UCI and/or CG-UCI of a first priority with one or more communications of a different second priority, as described above with respect to the schemes 400a, 400b, 500, 600, and/or 700.

In the scheme 800a shown in FIG. 8A, the UE is configured to bundle a plurality of HARQ-ACK bits associated with a plurality of transport blocks (TB s) into a single bundled bit 830. The HARQ-ACK bits include a first pair of bits 810 associated with a first PDSCH, and a second pair of bits 820 associated with a second PDSCH. The bits of each pair of bits 810, 820 may be associated with different TBs. In this regard, the BS may transmit multiple TBs in a PDSCH (e.g., with multi-TTI scheduling), and thus the UE may receive a first TB and a second TB in a first PDSCH and another first TB and second TB in a second PDSCH. With respect to the first pair of bits 810 of the first PDSCH, a first HARQ bit 812 is associated with a first TB, and the second HARQ bit 814 is associated with a second TB. With respect to the second pair of bits 820 of the second PDSCH, a third HARQ bit 822 is associated with the first TB, and a fourth HARQ bit 824 is associated with the second TB. The UE is configured to bundle all of the HARQ bits into a single HARQ bit 830 for multiplexing with UCI or CG-UCI. An HARQ-ACK may be represented by a bit value of 1, while an HARQ-NACK may be represented by a bit value of 0, and the bundling may include applying a logical AND operation across the multiple HARQ-ACK bits 812, 814, 822, and 824. In the example of FIG. 8A, because the fourth bit 824 is a zero, indicating a non-acknowledgement (NACK), the single bundled bit 830 indicates a NACK (zero) for all HARQ bits. In response to receiving the NACK included in the multiplexed communication, the BS may retransmit the DL communications (TBs) associated with all the HARQ-ACK bits including the TB(s) that were successfully received and decoded by the UE.

In the scheme 800b shown in FIG. 8B, the UE is configured to bundle a plurality of HARQ-ACK bits associated with a plurality of transport blocks (TBs) into one bundled bit for each associated TB. As similarly described above with respect to the scheme 800a, the HARQ-ACK bits include a first pair of bits 810 associated with a first PDSCH, and a second pair of bits 820 associated with a second PDSCH. The bits of each pair of bits 810, 820 may be associated with different TBs. With respect to the first pair of bits 810 of the first PDSCH, a first HARQ bit 812 is associated with a first TB received by the UE in the first PDSCH, and the second HARQ bit 814 is associated with a second TB received by the UE in the first PDSCH. With respect to the second pair of bits 820 of the second PDSCH, a third HARQ bit 822 is associated with a first TB received in the second PDSCH, and a fourth HARQ bit 824 is associated with a second TB received in the second PDSCH. The UE is configured to bundle the first and third HARQ bits 812, 822, which are associated with the first TB in the first PDSCH and the first TB in the second PDSCH, into a first HARQ bit 832. The UE is further configured to bundle the second and fourth HARQ bits 814, 824, which are associated with the second TB in the second PDSCH and the second TB in the second PDSCH, into a second bundled HARQ bit 834. The first and second bundled HARQ bits 832, 834 can be appended to a further UCI and/or CG-UCI communication for multiplexing. Similar to FIG. 8A, the bundling may include applying a logical AND operation across the HARQ-ACK bits 812 and 822 for the first TB of first PDSCH and the first TB of the second PDSCH, and applying a logical AND operation across the HARQ-ACK bits 814 and 824 for the second TB of first PDSCH and the second TB of the second PDSCH. In the example of FIG. 8B, because the fourth bit 824 is a zero, indicating a non-acknowledgement (NACK), the second bundled bit 834 indicates a NACK (zero) for the HARQ bits associated with the second TB, and the first bundled bit 832 indicates an ACK (one) for the HARQ bits associated with the first TB. In response to receiving the NACK included in the multiplexed communication, the BS may retransmit the DL communications associated with the second TB of the first PDSCH and the second TB of the PDSCH.

In the scheme 800c shown in FIG. 8C, the UE is configured to truncate or compress a UCI or CG communication, such as CSI part 1 or CG-UCI, based on a fixed number of bits. In some aspects, the fixed number of bits may be referred to as a threshold number of bits. The fixed number of bits is denoted in FIG. 8C as X. In the illustrated example, a first portion of the bits, denoted as X1, is allocated to bundled HARQ-ACK bits. The remaining X−X1 bits are allocated to the UCI or CG communication to be truncated or compressed. In the illustrated embodiment, the UCI or CG communication comprises a number of bits that is less than X-X 1. Accordingly, the UE appends or includes the actual, full number of bits of the UCI or CG communication. Further, the UE adds padding bits 840 to the end of the UCI or CG communication so that the total number of bits included for multiplexing equals the fixed number of bits 840. In other aspects, the number of bits of the UCI or CG communication may be greater than the remaining number of UCI bits X−X1. Accordingly, the UE may truncate UCI (e.g., CSI part 1) or the CG communication (e.g., CG-UCI) by selecting the first X−X1 bits of the UCI or CG communication. In that example, no padding bits are added.

In the scheme 800d shown in FIG. 8D, the UE is configured to truncate or compress a UCI or CG communication, such as CSI part 1 or CG-UCI, based on a variable number of bits having an upper bound. In some aspects, the upper bound of the variable number of bits may be referred to as a threshold number of bits. The variable number of bits is denoted in FIG. 8C as Xₘₐₓ. In the illustrated example, a first portion of the bits, denoted as X1, is allocated to bundled HARQ-ACK bits. The remaining Xₘₐₓ−X1 bits are allocated to the UCI or CG communication to be truncated or compressed. In the illustrated embodiment, the UCI or CG communication comprises a number of bits that is less than Xₘₐₓ−X1. Accordingly, the UE appends or includes the actual, full number of bits of the UCI or CG communication. The UE leaves any remaining bits 850 which fall below the upper bound of Xₘₐₓ unused. In other aspects, the number of bits of the UCI or CG communication may be greater than the remaining number of UCI bits Xₘₐₓ−X1. Accordingly, the UE may truncate UCI (e.g., CSI part 1) or the CG communication (e.g., CG-UCI) by selecting the first Xₘₐₓ−X1 bits of the UCI or CG communication. In that example, the sum of the bundled HARQ-ACK bits X1 and the truncated low-priority UCI or CG bits may equal Xₘₐₓ. The truncation may include dropping or excluding certain information parts in a certain order. As an example, CSI part 1 may include multiple information parts, such as RI, CRI, and/or CQI. The UE 115 may first drop the RI from CSI part 1. The UE 115 may further drop CRI if the number of low-priority UCI bits exceed Xₘₐₓ after dropping RI. As another example, CG-UCI may include multiple information parts, such as HARQ process ID, RV, NDI, and the UE 115 may drop the information parts in a certain order.

FIG. 9 is a block diagram of an exemplary UE 900 according to some aspects of the present disclosure. The UE 900 may be a UE 115 as discussed above in FIGS. 1 and 15. As shown, the UE 900 may include a processor 902, a memory 904, a UCI multiplexing module 908, a transceiver 910 including a modem subsystem 912 and a radio frequency (RF) unit 914, and one or more antennas 916. These elements may be in direct or indirect communication with each other, for example via one or more buses.

The processor 902 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 904 includes a non-transitory computer-readable medium. The memory 904 may store, or have recorded thereon, instructions 906. The instructions 906 may include instructions that, when executed by the processor 902, cause the processor 902 to perform the operations described herein with reference to the UE 115 in connection with aspects of the present disclosure, for example, aspects of FIGS. 5-10. Instructions 906 may also be referred to as code, which may be interpreted broadly to include any type of computer-readable statement(s) as discussed above.

The UCI multiplexing module 908 may be implemented via hardware, software, or combinations thereof. For example, the UCI multiplexing module 908 may be implemented as a processor, circuit, and/or instructions 906 stored in the memory 904 and executed by the processor 902. In some instances, the UCI multiplexing module 908 can be integrated within the modem subsystem 912. For example, the UCI multiplexing module 908 can be implemented by a combination of software components (e.g., executed by a DSP or a general processor) and hardware components (e.g., logic gates and circuitry) within the modem subsystem 912.

The UCI multiplexing module 908 may communicate with one or more components of UE 900 to implement various aspects of the present disclosure, for example, aspects of FIGS. 3-8D. For instance, the UCI multiplexing module 908 may be configured to determine that a physical uplink control channel (PUCCH) resource at least partially overlaps with a configured grant physical uplink shared channel (CG-PUSCH) resource, where the PUCCH resource and the CG-PUSCH resource are associated with different priorities. The UCI multiplexing module 908 may determine that a PUCCH resource overlaps with a CG-PUSCH resource by determining whether a PUCCH resource, such as UCI, is scheduled or present in a same set of time/frequency resources as a CG-PUSCH communication, such as CG-UCI.

The UCI multiplexing module 908 may be further configured to determine, based on a threshold number of bits, a number of bits of a low-priority uplink control information (UCI) for multiplexing with at least one of a high-priority CG-PUSCH transmission, a low-priority CG-PUSCH transmission, or a high-priority UCI. In some aspects, determining the number of low-priority UCI bits for multiplexing may include determining the number of low-priority UCI bits based on a fixed configured number of bits or a variable configured number of bits (with an upper bound). The configured number of bits may be referred to as a threshold number of bits. In some aspects, determining the number of low-priority UCI bits includes adding padding bits when the number of low-priority UCI bits is less than a fixed threshold of bits allocated for low-priority UCI (X). In other aspects, determining the number of low-priority UCI bits includes determining whether an actual number of low-priority UCI bits equals or falls below an upper bound (Xₘₐₓ), and determining whether to transmit the actual, non-truncated low-priority UCI bits based on the determining. Further, determining the number of low-priority UCI bits for multiplexing with the CG communication may include bundling, truncating, or compressing all or a portion of the low-priority UCI bits. In some aspects, the low-priority UCI may include a low-priority HARQ-ACK and a CSI part 1. The UCI multiplexing module 908 may be configured to bundle the low-priority HARQ-ACK to one, two, three, or any other suitable number of bits. The UCI multiplexing module 908 may be further configured to truncate the CSI part 1 bits based on the bundled number of HARQ-ACK bits and the preconfigured threshold number of bits.

In some aspects, the UCI multiplexing module 908 is configured to multiplex the number of bits of the low-priority UCI with the at least one of the high-priority CG-PUSCH transmission, the low-priority CG-PUSCH transmission, or the high-priority UCI to generate a multiplexed uplink transmission. Multiplexing the low-priority UCI with the at least one of the high-priority CG-PUSCH transmission, the low-priority CG-PUSCH transmission, or the high-priority UCI may include appending and encoding the low-priority UCI with the high-priority UCI, the high-priority CG-PUSCH transmission, or the low-priority CG-PUSCH transmission according to a certain order. For example, the UCI multiplexing module 908 may append high-priority UCI, such as a high-priority HARQ-ACK to high-priority CG-UCI. The UCI multiplexing module 908 may also bundle and/or truncate low-priority UCI bits, and append the bundled and/or truncated low-priority UCI bits to the high-priority CG-UCI and high-priority UCI. The low-priority UCI may include a low-priority HARQ-ACK and/or low-priority CSI, such as a CSI part 1. The UCI multiplexing module 908 may then encode the appended low-priority UCI bits, high-priority CG-UCI and high-priority UCI to generate an encoded block. The UCI multiplexing module 908 may then multiplex the encoded block for transmission.

In some aspects, the UCI multiplexing module 908 is configured to cooperate with the transceiver 910 to transmit the multiplexed uplink transmission in the PUCCH resource or the CG-PUSCH resource. For example, the UCI multiplexing module 908 may cause the transceiver 910 transmit the multiplexed uplink transmission in a scheduled high-priority resource. Alternatively, the UE may transmit the multiplexed uplink transmission in a configured or non-scheduled CG resource.

As shown, the transceiver 910 may include the modem subsystem 912 and the RF unit 914. The transceiver 910 can be configured to communicate bi-directionally with other devices, such as the BS s 105 and 1000. The modem subsystem 912 may be configured to modulate and/or encode the data from the memory 904 and/or the UCI multiplexing module 908 according to a modulation and coding scheme (MCS), e.g., a low-density parity check (LDPC) coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data (e.g., HARQ ACK/NACK) from the modem subsystem 912 (on outbound transmissions) or of transmissions originating from another source such as a UE 115 or a BS 105. The RF unit 914 may be further configured to perform analog beamforming in conjunction with the digital beamforming. Although shown as integrated together in transceiver 910, the modem subsystem 912 and the RF unit 914 may be separate devices that are coupled together at the UE 115 to enable the UE 115 to communicate with other devices.

The RF unit 914 may provide the modulated and/or processed data, e.g. data packets (or, more generally, data messages that may contain one or more data packets and other information), to the antennas 916 for transmission to one or more other devices. The antennas 916 may further receive data messages transmitted from other devices. The antennas 916 may provide the received data messages for processing and/or demodulation at the transceiver 910. The transceiver 910 may provide the demodulated and decoded data (e.g., RRC configurations and SPS configurations, activations, reactivations, and releases, PDSCH data, DCI) to the UCI multiplexing module 908 for processing. The antennas 916 may include multiple antennas of similar or different designs in order to sustain multiple transmission links.

In an example, the transceiver 910 is configured to communicate with one or more components of the UE 900 to receive a multiplexing configuration from a BS and transmit multiplexed UCI and/or CG transmissions to a BS, such as the BS 1000.

In an aspect, the UE 900 can include multiple transceivers 910 implementing different RATs (e.g., NR and LTE). In an aspect, the UE 900 can include a single transceiver 910 implementing multiple RATs (e.g., NR and LTE). In an aspect, the transceiver 910 can include various components, where different combinations of components can implement different RATs.

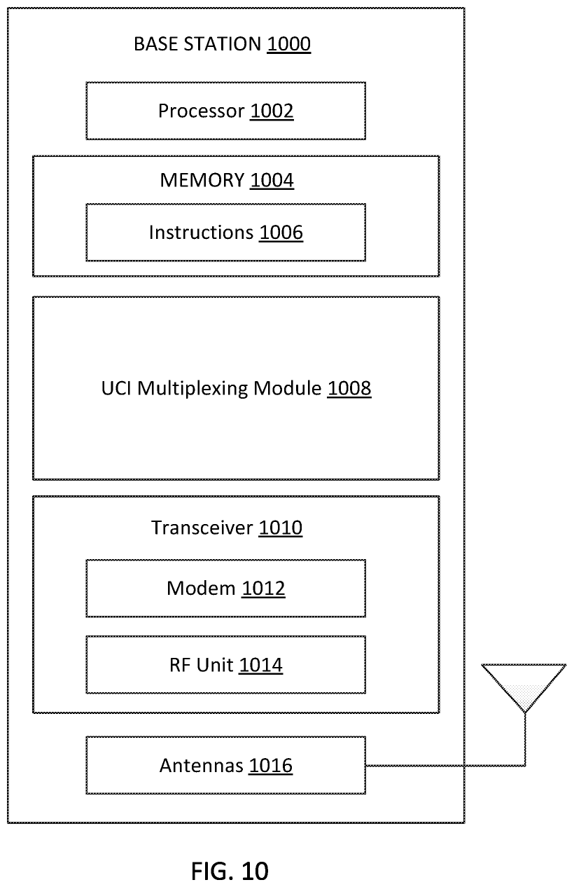

FIG. 10 is a block diagram of an exemplary BS 1000 according to some aspects of the present disclosure. The BS 1000 may be a BS 105 as discussed in FIG. 1. A shown, the BS 1000 may include a processor 1002, a memory 1004, a UCI multiplexing module 1008, a transceiver 1010 including a modem subsystem 1012 and a RF unit 1014, and one or more antennas 1016. These elements may be in direct or indirect communication with each other, for example via one or more buses.

The processor 1002 may have various features as a specific-type processor. For example, these may include a CPU, a DSP, an ASIC, a controller, a FPGA device, another hardware device, a firmware device, or any combination thereof configured to perform the operations described herein. The processor 1002 may also be implemented as a combination of computing devices, e.g., a combination of a DSP and a microprocessor, a plurality of microprocessors, one or more microprocessors in conjunction with a DSP core, or any other such configuration.

The memory 1004 may include a cache memory (e.g., a cache memory of the processor 1002), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 1004 may include a non-transitory computer-readable medium. The memory 1004 may store instructions 1006. The instructions 1006 may include instructions that, when executed by the processor 1002, cause the processor 1002 to perform operations described herein, for example, aspects of FIGS. 2-6, 9, and 11. Instructions 1006 may also be referred to as program code. The program code may be for causing a wireless communication device to perform these operations, for example by causing one or more processors (such as processor 1002) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The UCI multiplexing module 1008 may be implemented via hardware, software, or combinations thereof. For example, the UCI multiplexing module 1008 may be implemented as a processor, circuit, and/or instructions 1006 stored in the memory 1004 and executed by the processor 1002. In some examples, the UCI multiplexing module 1008 can be integrated within the modem subsystem 1012. For example, the UCI multiplexing module 1008 can be implemented by a combination of software components (e.g., executed by a DSP or a general processor) and hardware components (e.g., logic gates and circuitry) within the modem subsystem 1012.

The UCI multiplexing module 1008 may communicate with one or more components of BS 1000 to implement various aspects of the present disclosure, for example, aspects of FIGS. 3-8D. For example, the UCI multiplexing module 1008 may be configured to cooperate with the transceiver 1010 to receive a multiplexed transmission from the UE 900 including low-priority UCI and at least one of high-priority UCI, high-priority CG-UCI, or low-priority CG-UCI. The UCI multiplexing module 1008 may be further configured to de-multiplex and/or decode the received multiplexed low-priority UCI, high-priority UCI, high-priority CG-UCI, and/or low-priority CG-UCI. The UCI multiplexing module 1008 may be further configured to transmit a multiplexing configuration to the UE 900, the configuration including instructions to perform the protocols and/or steps described above with respect to the schemes 400, 500, 600, 700, and/or 800.

As shown, the transceiver 1010 may include the modem subsystem 1012 and the RF unit 1014. The transceiver 1010 can be configured to communicate bi-directionally with other devices, such as the UEs 115 and/or 900 and/or another core network element. The modem subsystem 1012 may be configured to modulate and/or encode data according to a MCS, e.g., a LDPC coding scheme, a turbo coding scheme, a convolutional coding scheme, a digital beamforming scheme, etc. The RF unit 1014 may be configured to process (e.g., perform analog to digital conversion or digital to analog conversion, etc.) modulated/encoded data (e.g., RRC configurations, SPS configurations, activations, reactivations, and releases, and PDSCH data, DCI) from the modem subsystem 1012 (on outbound transmissions) or of transmissions originating from another source such as a UE 115 and/or UE 900. The RF unit 1014 may be further configured to perform analog beamforming in conjunction with the digital beamforming. Although shown as integrated together in transceiver 1010, the modem subsystem 1012 and/or the RF unit 1014 may be separate devices that are coupled together at the BS 1000 to enable the BS 1000 to communicate with other devices.

The RF unit 1014 may provide the modulated and/or processed data, e.g. data packets (or, more generally, data messages that may contain one or more data packets and other information), to the antennas 1016 for transmission to one or more other devices. The antennas 1016 may further receive data messages transmitted from other devices and provide the received data messages for processing and/or demodulation at the transceiver 1010. The transceiver 1010 may provide the demodulated and decoded data (e.g., HARQ ACK/NACK, etc.) to the UCI multiplexing module 1008 for processing. The antennas 1016 may include multiple antennas of similar or different designs in order to sustain multiple transmission links.

In an aspect, the BS 1000 can include multiple transceivers 1010 implementing different RATs (e.g., NR and LTE). In an aspect, the BS 1000 can include a single transceiver 1010 implementing multiple RATs (e.g., NR and LTE). In an aspect, the transceiver 1010 can include various components, where different combinations of components can implement different RATs.

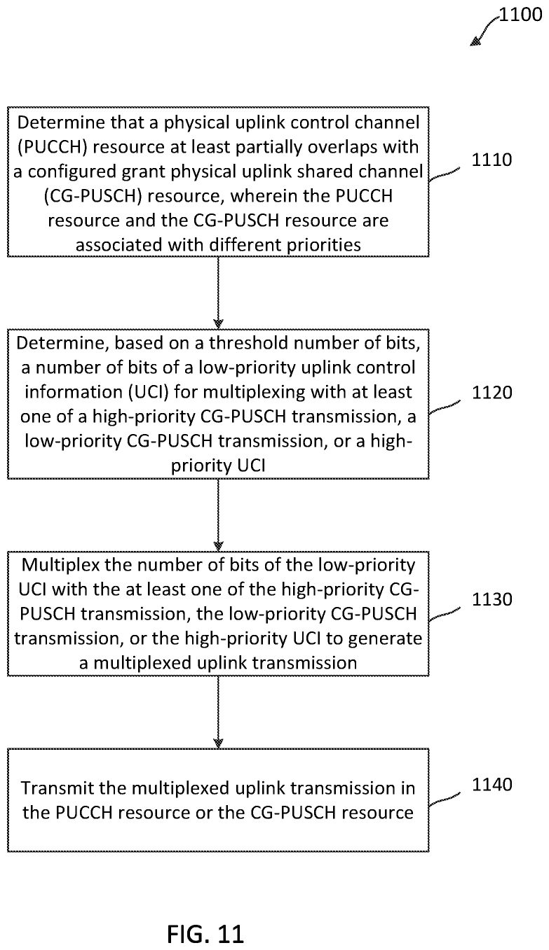

FIG. 11 is a flow diagram illustrating a communication method 1100 according to some aspects of the present disclosure. Aspects of the method 1100 can be executed by a computing device (e.g., a processor, processing circuit, and/or other suitable component) of a wireless communication device or other suitable means for performing the steps. For example, a wireless communication device, such as a UE 115 or the UE 900, may utilize one or more components, such as the processor 902, the memory 904, the UCI multiplexing module 908, the transceiver 910, the modem 912, and the one or more antennas 916, to execute the steps of method 1100. The method 1100 may employ similar mechanisms as described in FIGS. 4A-8D. As illustrated, the method 1100 includes a number of enumerated steps, but aspects of the method 1100 may include additional steps before, after, and in between the enumerated steps. In some aspects, one or more of the enumerated steps may be omitted or performed in a different order.

At block 1110, the UE determines that a physical uplink control channel (PUCCH) resource at least partially overlaps with a configured grant physical uplink shared channel (CG-PUSCH) resource, where the PUCCH resource and the CG-PUSCH resource are associated with different priorities. The UE may determine that a PUCCH resource overlaps with a CG-PUSCH resource by determining whether a PUCCH resource, such as UCI, is scheduled or present in a same set of time/frequency resources as a CG-PUSCH communication, such as CG-UCI. In some aspects, the UE may utilize one or more components, such as the processor 902, the memory 904, the UCI multiplexing module 908, the transceiver 910, the modem 912, and the one or more antennas 916, to perform the operations at block 1110.

At block 1120, the UE determines, based on a threshold number of bits, a number of bits of a low-priority uplink control information (UCI) for multiplexing with at least one of a high-priority CG-PUSCH transmission, a low-priority CG-PUSCH transmission, or a high-priority UCI. In some aspects, determining the number of low-priority UCI bits for multiplexing may include determining the number of low-priority UCI bits based on a fixed configured number of bits or a variable configured number of bits (with an upper bound). The configured number of bits may be referred to as a threshold number of bits. In some aspects, determining the number of low-priority UCI bits includes adding padding bits when the number of low-priority UCI bits is less than a fixed threshold of bits allocated for low-priority UCI (X). In other aspects, determining the number of low-priority UCI bits includes determining whether an actual number of low-priority UCI bits equals or falls below an upper bound (Xₘₐₓ), and determining whether to transmit the actual, non-truncated low-priority UCI bits based on the determining. Further, determining the number of low-priority UCI bits for multiplexing with the CG communication may include bundling, truncating, or compressing all or a portion of the low-priority UCI bits. In some aspects, the low-priority UCI may include a low-priority HARQ-ACK and a CSI part 1. The UE may be configured to bundle the low-priority HARQ-ACK to one, two, three, or any other suitable number of bits. The UE may be further configured to truncate the CSI part 1 bits based on the bundled number of HARQ-ACK bits and the preconfigured threshold number of bits. In some aspects, the UE may utilize one or more components, such as the processor 902, the memory 904, the UCI multiplexing module 908, the transceiver 910, the modem 912, and the one or more antennas 916, to perform the operations at block 1120.

At block 1130, the UE multiplexes the number of bits of the low-priority UCI with the at least one of the high-priority CG-PUSCH transmission, the low-priority CG-PUSCH transmission, or the high-priority UCI to generate a multiplexed uplink transmission. Multiplexing the low-priority UCI with the at least one of the high-priority CG-PUSCH transmission, the low-priority CG-PUSCH transmission, or the high-priority UCI may include appending and encoding the low-priority UCI with the high-priority UCI, the high-priority CG-PUSCH transmission, or the low-priority CG-PUSCH transmission according to a certain order. For example, the UE may append high-priority UCI, such as a high-priority HARQ-ACK to high-priority CG-UCI. The UE may also bundle and/or truncate low-priority UCI bits, and append the bundled and/or truncated low-priority UCI bits to the high-priority CG-UCI and high-priority UCI. The low-priority UCI may include a low-priority HARQ-ACK and/or low-priority CSI, such as a CSI part 1. The UE may then encode the appended low-priority UCI bits, high-priority CG-UCI and high-priority UCI to generate an encoded block. The UE then multiplexes the encoded block for transmission. In some aspects, the UE may utilize one or more components, such as the processor 902, the memory 904, the UCI multiplexing module 908, the transceiver 910, the modem 912, and the one or more antennas 916, to perform the operations at block 1130.

At block 1140, the UE transmits the multiplexed uplink transmission in the PUCCH resource or the CG-PUSCH resource. For example, the UE may transmit the multiplexed uplink transmission in a scheduled high-priority resource. Alternatively, the UE may transmit the multiplexed uplink transmission in a configured or non-scheduled CG resource. In some aspects, the UE may utilize one or more components, such as the processor 902, the memory 904, the UCI multiplexing module 908, the transceiver 910, the modem 912, and the one or more antennas 916, to perform the operations at block 1140.

In some aspects, determining the number of bits at block 1120 includes determining a fixed number of bits of the low priority UCI based on the threshold number of bits. In some aspects, the determining the number of bits at block 1120 includes determining that a number of bits of the low priority UCI is less than the threshold number of bits. In some aspects, the multiplexing the number of bits of the low priority UCI includes adding one or more padding bits to the number of bits of the low priority UCI. In some aspects, the determining the number of bits at block 1120 includes determining a variable that is no more than the threshold number of bits. In some aspects, the high-priority CG-PUSCH includes CG-UCI and data. In some aspects, the low priority UCI includes at least one of a low priority HARQ-ACK or low priority CSI. In some aspects, the multiplexing at block 1130 includes multiplexing, based on a multiplexing configuration being enabled, the high-priority CG-PUSCH transmission with the at least one of the low priority HARQ-ACK or the low priority CSI. In some aspects, the transmitting at block 1140 includes transmitting the multiplexed uplink transmission in a high-priority CG-PUSCH resource. Further, in some aspects, the low priority UCI includes at least the low priority HARQ-ACK, the high-priority UCI includes a high-priority HARQ-ACK, and the multiplexing includes: generating a first block by appending the high-priority HARQ-ACK to the CG-UCI and appending the low-priority HARQ-ACK to the high-priority HARQ-ACK, encoding the first block, and multiplexing the encoded first block with the data. In some aspects, the low-priority UCI includes at least the low-priority CSI, and the multiplexing further includes: encoding the CG-UCI into a first block; encoding the low priority CSI into a second block; and multiplexing the first block and the second block with the data.

Further, in some aspects, the low-priority UCI comprises at least one of a low-priority HARQ-ACK or a low-priority CSI. In some aspects, the method 1100 further includes refraining, based on a multiplexing configuration being disabled, from transmitting the high-priority CG-PUSCH. In some aspects, the multiplexing at block 1130 includes: generating a first block by appending the low-priority UCI to the high-priority HARQ-ACK, and encoding the first block, and the transmitting the multiplexed uplink transmission includes: transmitting, based on the multiplexing configuration being disabled, the multiplexed uplink transmission in a PUCCH resource.

In some aspects, the low-priority UCI includes the low-priority HARQ-ACK, and the low-priority CSI, and the generating the first block includes: appending the low-priority HARQ-CK to the high-priority HARQ-ACK, and appending the low-priority CSI to the low-priority HARQ-ACK.

In some aspects, the low-priority CG-PUSCH transmission comprises CG-UCI and data, the low-priority UCI comprises a low-priority HARQ-ACK, and the high-priority UCI comprises a high-priority HARQ-ACK. In some aspects, the multiplexing at block 1130 includes: encoding, based on a multiplexing configuration being enabled, the high-priority HARQ-ACK with the low-priority HARQ-ACK and the CG-UCI into an encoded block; and multiplexing the encoded block with the data. In some aspects, the encoding includes: generating a first block by appending the low-priority HARQ-CK to the CG-UCI, and appending the high-priority HARQ-ACK to the low-priority HARQ-ACK, and encoding the first block. In some aspects, the transmitting at block 1140 includes transmitting the multiplexed uplink transmission in a low-priority CG-PUSCH resource. In some aspects, the low-priority UCI includes a low-priority HARQ-ACK comprising a first number of bits, and the determining the number of bits at block 1120 includes: subtracting the first number of bits from the threshold number of bits to determine a second number of bits; and selecting the second number of bits from the CG-UCI.

In some aspects, the low-priority UCI includes at least one of a low-priority HARQ-ACK or low-priority CSI, and the high-priority UCI comprises a high-priority HARQ-ACK. In some aspects, the method 1100 further includes: refraining, based on a multiplexing configuration being disabled, from transmitting the low-priority CG-PUSCH transmission. In some aspects, the multiplexing at block 1130 includes generating a first block by appending the low-priority UCI to the high-priority HARQ-ACK, and encoding the first block. In some aspects, the low-priority UCI includes the low-priority HARQ-ACK and the low-priority CSI, and the generating the first block includes appending the low-priority HARQ-ACK to the high-priority HARQ-ACK, and appending the low-priority CSI to the low-priority HARQ-ACK. In some aspects, the transmitting the multiplexed uplink transmission at block 1140 includes: transmitting, based on the multiplexing configuration for multiplexing CG-PUSCH and HARQ-ACK being disabled, the multiplexed uplink transmission in a PUCCH resource.

In some aspects, the low-priority UCI includes: a low-priority HARQ-ACK comprising a plurality of HARQ-ACK bits for a plurality of transport blocks, and the determining the number of bits in block 1120 includes bundling the low-priority HARQ-ACK into a single bit. In some aspects, the low-priority UCI includes: a low-priority HARQ-ACK comprising a plurality of HARQ-ACK bits for a plurality of transport blocks, and the determining the number of bits at block 1120 includes: bundling the low-priority HARQ-ACK into one bit for a first transport block of the plurality of transport blocks and into another bit for a second transport block of the plurality of transport blocks. In some aspects, the low-priority UCI includes: a low-priority HARQ-ACK comprising a first number of bits; and CSI. In some aspects, the determining the number of bits at block 1120 includes: subtracting the first number of bits from the threshold number of bits to determine a truncated number of bits; and selecting the truncated number of bits from the CSI.

Low-priority information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Aspects of the present disclosure include the following:
1. A method of wireless communication performed by a user equipment (UE), the method comprising:
   determining that a physical uplink control channel (PUCCH) resource at least partially overlaps with a configured grant physical uplink shared channel (CG-PUSCH) resource, wherein the PUCCH resource and the CG-PUSCH resource are associated with different priorities;
   determining, based on a threshold number of bits, a number of bits of a low-priority uplink control information (UCI) for multiplexing with at least one of a high-priority CG-PUSCH transmission, a low-priority CG-PUSCH transmission, or a high-priority UCI;
   multiplexing the number of bits of the low-priority UCI with the at least one of the high-priority CG-PUSCH transmission, the low-priority CG-PUSCH transmission, or the high-priority UCI to generate a multiplexed uplink transmission; and
   transmitting the multiplexed uplink transmission in the PUCCH resource or the CG-PUSCH resource.
2. The method of clause 1, wherein the number of bits comprises a fixed number of bits.
3. The method of clause 2, wherein:
   the determining comprises:
      determining that a number of bits of the low-priority UCI is less than the threshold number of bits, and
   the multiplexing the number of bits of the low-priority UCI comprises adding one or more padding bits to the number of bits of the low-priority UCI.
4. The method of clause 1, wherein the number of bits is variable and no more than the threshold number of bits.
5. The method of any of clauses 1-4, wherein:
   the high-priority CG-PUSCH comprises configured grant-UCI (CG-UCI) and data,
   the low-priority UCI comprises at least one of a low-priority hybrid automatic repeat request-acknowledgement (HARQ-ACK) or low-priority channel state information (CSI),
   the multiplexing comprises:
      multiplexing, based on a multiplexing configuration being enabled, the high-priority CG-PUSCH transmission with the at least one of the low-priority HARQ-ACK or the low-priority CSI, and
   the transmitting comprises:
      transmitting the multiplexed uplink transmission in a high-priority CG-PUSCH resource.
6. The method of clause 5, wherein:
   the low-priority UCI comprises at least the low-priority HARQ-ACK,
   the high-priority UCI comprises a high-priority HARQ-ACK, and
   the multiplexing comprises:
      generating a first block by appending the high-priority HARQ-ACK to the CG-UCI and appending the low-priority HARQ-ACK to the high-priority HARQ-ACK;
      encoding the first block; and
      multiplexing the encoded first block with the data.
7. The method of clause 5, wherein:
   the low-priority UCI comprises at least the low-priority CSI, and
   the multiplexing further comprises:
      encoding the CG-UCI into a first block;
      encoding the low priority CSI into a second block; and
      multiplexing the first block and the second block with the data.
8. The method of any of clauses 1-4, wherein:
   the low-priority UCI comprises at least one of a low-priority hybrid automatic repeat request-acknowledgement (HARQ-ACK) or low-priority channel state information (CSI),
   the high-priority UCI comprises a high-priority HARQ-ACK,
   the method further comprises:
      refraining, based on a multiplexing configuration being disabled, from transmitting the high-priority CG-PUSCH,
   the multiplexing comprises:
      generating a first block by appending the low-priority UCI to the high-priority HARQ-ACK; and
      encoding the first block, and
   the transmitting the multiplexed uplink transmission comprises:
      transmitting, based on the multiplexing configuration being disabled, the multiplexed uplink transmission in a PUCCH resource.
9. The method of clause 8, wherein:
   the low-priority UCI comprises the low-priority HARQ-ACK and the low-priority CSI, and
   the generating the first block further comprises:
      appending the low-priority HARQ-ACK to the high-priority HARQ-ACK;
      appending the low-priority CSI to the low-priority HARQ-ACK.
10. The method of any of clauses 1-4, wherein:
   the low-priority CG-PUSCH transmission comprises CG-UCI and data,
   the low-priority UCI comprises a low-priority HARQ-ACK,
   the high-priority UCI comprises a high-priority HARQ-ACK,
   the multiplexing comprises:
      encoding, based on a multiplexing configuration being enabled, the high-priority HARQ-ACK with the low-priority HARQ-ACK and the CG-UCI into an encoded block, the encoding comprises:
         generating a first block by appending the low-priority HARQ-ACK to the CG-UCI and appending the high-priority HARQ-ACK to the low-priority HARQ-ACK; and
         encoding the first block; and
      multiplexing the encoded block with the data, and
   the transmitting comprises:
      transmitting the multiplexed uplink transmission in a low-priority CG-PUSCH resource.
11. The method of clause 10, wherein
   the low-priority UCI comprises:
      a low-priority HARQ-ACK comprising a first number of bits, and
   the determining comprises:
      subtracting the first number of bits from the threshold number of bits to determine a second number of bits; and
      selecting the second number of bits from the CG-UCI.
12. The method of any of clauses 1-4, wherein:
   the low-priority UCI comprises at least one of a low-priority hybrid automatic repeat request-acknowledgement (HARQ-ACK) or low-priority channel state information (CSI),
   the high-priority UCI comprises a high-priority HARQ-ACK,
   the method further comprises:
      refraining, based on a multiplexing configuration being disabled, from transmitting the low-priority CG-PUSCH transmission,
   the multiplexing comprises:
      generating a first block by appending the low-priority UCI to the high-priority HARQ-ACK; and
      encoding the first block, and
   the transmitting the multiplexed uplink transmission comprises:
      transmitting, based on the multiplexing configuration for multiplexing CG-PUSCH and HARQ-ACK being disabled, the multiplexed uplink transmission in a PUCCH resource.
13. The method of clause 12, wherein:
   the low-priority UCI comprises the low-priority HARQ-ACK and the low-priority CSI, and
   the generating the first block further comprises:
      appending the low-priority HARQ-ACK to the high-priority HARQ-ACK;
      appending the low-priority CSI to the low-priority HARQ-ACK.
14. The method of any of clauses 1-13, wherein:
   the low-priority UCI comprises:
      a low-priority HARQ-ACK comprising a plurality of HARQ-ACK bits for a plurality of transport blocks, and
   the determining comprises:
      bundling the low-priority HARQ-ACK into a single bit.
15. The method of any of clauses 1-13, wherein:
   the low-priority UCI comprises:
      a low-priority HARQ-ACK comprising a plurality of HARQ-ACK bits for a plurality of transport blocks, and
   the determining comprises:
      bundling the low-priority HARQ-ACK into one bit for the first transport block of the plurality of transport blocks and into another bit for the second transport block of the plurality of transport blocks.
16. The method of any of clauses 1-15, wherein
   the low-priority UCI comprises:
      a low-priority HARQ-ACK comprising a first number of bits; and
      a channel state information (CSI), and
   the determining comprises:
      subtracting the first number of bits from the threshold number of bits to determine a truncated number of bits; and
      selecting the truncated number of bits from the CSI.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C). The terms “about” or “approximately” may be used to denote a range of +/−2%, unless specified otherwise.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some examples thereof, but rather, should be fully commensurate with that of the claims appended hereafter and their functional equivalents.

What is claimed is:

1. A method of wireless communication performed by a user equipment (UE), the method comprising:
determining that a physical uplink control channel (PUCCH) resource at least partially overlaps with a configured grant physical uplink shared channel (CG-PUSCH) resource, wherein the PUCCH resource and the CG-PUSCH resource are associated with different priorities;
determining, based on a threshold number of bits, a number of bits of a low-priority uplink control information (UCI) for multiplexing with at least one of a high-priority CG-PUSCH transmission, a low-priority CG-PUSCH transmission, or a high-priority UCI;
multiplexing the number of bits of the low-priority UCI with the at least one of the high-priority CG-PUSCH transmission, the low-priority CG-PUSCH transmission, or the high-priority UCI to generate a multiplexed uplink transmission; and
transmitting the multiplexed uplink transmission in the PUCCH resource or the CG-PUSCH resource.

2. The method of claim 1, wherein the number of bits comprises a fixed number of bits.

3. The method of claim 2, wherein:
the determining comprises:
determining that a number of bits of the low-priority UCI is less than the threshold number of bits, and
the multiplexing the number of bits of the low-priority UCI comprises adding one or more padding bits to the number of bits of the low-priority UCI.

4. The method of claim 1, wherein the number of bits is variable and no more than the threshold number of bits.

5. The method of claim 1, wherein:
the high-priority CG-PUSCH comprises configured grant-UCI (CG-UCI) and data,
the low-priority UCI comprises at least one of a low-priority hybrid automatic repeat request-acknowledgement (HARQ-ACK) or low-priority channel state information (CSI),
the multiplexing comprises:
multiplexing, based on a multiplexing configuration being enabled, the high-priority CG-PUSCH transmission with the at least one of the low-priority HARQ-ACK or the low-priority CSI, and
the transmitting comprises:
transmitting the multiplexed uplink transmission in a high-priority CG-PUSCH resource.

6. The method of claim 5, wherein:
the low-priority UCI comprises at least the low-priority HARQ-ACK,
the high-priority UCI comprises a high-priority HARQ-ACK, and
the multiplexing comprises:
generating a first block by appending the high-priority HARQ-ACK to the CG-UCI and appending the low-priority HARQ-ACK to the high-priority HARQ-ACK;
encoding the first block; and
multiplexing the encoded first block with the data.

7. The method of claim 5, wherein:
the low-priority UCI comprises at least the low-priority CSI, and
the multiplexing further comprises:
encoding the CG-UCI into a first block;
encoding the low priority CSI into a second block; and
multiplexing the first block and the second block with the data.

8. The method of claim 1, wherein:
the low-priority UCI comprises at least one of a low-priority hybrid automatic repeat request-acknowledgement (HARQ-ACK) or low-priority channel state information (CSI),
the high-priority UCI comprises a high-priority HARQ-ACK,
the method further comprises:
refraining, based on a multiplexing configuration being disabled, from transmitting the high-priority CG-PUSCH,
the multiplexing comprises:
generating a first block by appending the low-priority UCI to the high-priority HARQ-ACK; and
encoding the first block, and
the transmitting the multiplexed uplink transmission comprises:
transmitting, based on the multiplexing configuration being disabled, the multiplexed uplink transmission in a PUCCH resource.

9. The method of claim 8, wherein:
the low-priority UCI comprises the low-priority HARQ-ACK and the low-priority CSI, and
the generating the first block further comprises:
appending the low-priority HARQ-ACK to the high-priority HARQ-ACK; and
appending the low-priority CSI to the low-priority HARQ-ACK.

10. The method of claim 1, wherein:
the low-priority CG-PUSCH transmission comprises CG-UCI and data,
the low-priority UCI comprises a low-priority HARQ-ACK,
the high-priority UCI comprises a high-priority HARQ-ACK,
the multiplexing comprises:
encoding, based on a multiplexing configuration being enabled, the high-priority HARQ-ACK with the low-priority HARQ-ACK and the CG-UCI into an encoded block, the encoding comprises:
generating a first block by appending the low-priority HARQ-ACK to the CG-UCI and appending the high-priority HARQ-ACK to the low-priority HARQ-ACK; and
encoding the first block; and
multiplexing the encoded block with the data, and
the transmitting comprises:
transmitting the multiplexed uplink transmission in a low-priority CG-PUSCH resource.

11. The method of claim 10, wherein
the low-priority UCI comprises:
a low-priority HARQ-ACK comprising a first number of bits, and
the determining comprises:
subtracting the first number of bits from the threshold number of bits to determine a second number of bits; and
selecting the second number of bits from the CG-UCI.

12. The method of claim 1, wherein:
the low-priority UCI comprises at least one of a low-priority hybrid automatic repeat request-acknowledgement (HARQ-ACK) or low-priority channel state information (CSI),
the high-priority UCI comprises a high-priority HARQ-ACK,
the method further comprises:
refraining, based on a multiplexing configuration being disabled, from transmitting the low-priority CG-PUSCH transmission,
the multiplexing comprises:
generating a first block by appending the low-priority UCI to the high-priority HARQ-ACK; and
encoding the first block, and
the transmitting the multiplexed uplink transmission comprises:
transmitting, based on the multiplexing configuration for multiplexing CG-PUSCH and HARQ-ACK being disabled, the multiplexed uplink transmission in a PUCCH resource.

13. The method of claim 12, wherein:
the low-priority UCI comprises the low-priority HARQ-ACK and the low-priority CSI, and
the generating the first block further comprises:
appending the low-priority HARQ-ACK to the high-priority HARQ-ACK; and
appending the low-priority CSI to the low-priority HARQ-ACK.

14. The method of claim 1, wherein:
the low-priority UCI comprises:
a low-priority HARQ-ACK comprising a plurality of HARQ-ACK bits for a plurality of transport blocks, and
the determining comprises:
bundling the low-priority HARQ-ACK into a single bit.

15. The method of claim 1, wherein:
the low-priority UCI comprises:
a low-priority HARQ-ACK comprising a plurality of HARQ-ACK bits for a plurality of transport blocks, and
the determining comprises:
bundling the low-priority HARQ-ACK into one bit for a first transport block of the plurality of transport blocks and into another bit for a second transport block of the plurality of transport blocks.

16. The method of claim 1, wherein
the low-priority UCI comprises:
a low-priority HARQ-ACK comprising a first number of bits; and
a channel state information (CSI), and
the determining comprises:
subtracting the first number of bits from the threshold number of bits to determine a truncated number of bits; and
selecting the truncated number of bits from the CSI.

17. A user equipment (UE), comprising:
a processor configured to:
determine that a physical uplink control channel (PUCCH) resource at least partially overlaps with a configured grant physical uplink shared channel (CG-PUSCH) resource, wherein the PUCCH resource and the CG-PUSCH resource are associated with different priorities;
determine, based on a threshold number of bits, a number of bits of a low-priority uplink control information (UCI) for multiplexing with at least one of a high-priority CG-PUSCH transmission, a low-priority CG-PUSCH transmission, or a high-priority UCI; and
multiplex the number of bits of the low-priority UCI with the at least one of the high-priority CG-PUSCH transmission, the low-priority CG-PUSCH transmission, or the high-priority UCI to generate a multiplexed uplink transmission; and
a transceiver configured to:
transmit the multiplexed uplink transmission in the PUCCH resource or the CG-PUSCH resource.

18. The UE of claim 17, wherein the number of bits comprises a fixed number of bits.

19. The UE of claim 18, wherein:
the processor configured to determine the number of bits comprises the processor configured to:
determine that a number of bits of the low-priority UCI is less than the threshold number of bits, and
the processor configured to multiplex the number of bits of the low-priority UCI comprises processor configured to:
add one or more padding bits to the number of bits of the low-priority UCI.

20. The UE of claim 17, wherein the number of bits is variable and no more than the threshold number of bits.

21. The UE of claim 17, wherein:
the high-priority CG-PUSCH comprises configured grant-UCI (CG-UCI) and data,
the low-priority UCI comprises at least one of a low-priority hybrid automatic repeat request-acknowledgement (HARQ-ACK) or low-priority channel state information (CSI),
the processor configured to multiplex comprises the processor configured to:
multiplex, based on a multiplexing configuration being enabled, the high-priority CG-PUSCH transmission with the at least one of the low-priority HARQ-ACK or the low-priority CSI, and
the transceiver configured to transmit comprises the transceiver configured to:
transmit the multiplexed uplink transmission in a high-priority CG-PUSCH resource.

22. The UE of claim 21, wherein:
the low-priority UCI comprises at least the low-priority HARQ-ACK,
the high-priority UCI comprises a high-priority HARQ-ACK, and
the processor configured to multiplex comprises the processor configured to:
generate a first block by appending the high-priority HARQ-ACK to the CG-UC and appending the low-priority HARQ-ACK to the high-priority HARQ-ACK;
encode the first block; and
multiplex the encoded first block with the data.

23. The UE of claim 21, wherein:
the low-priority UCI comprises at least the low-priority CSI, and
the processor configured to multiplex further comprises the processor configured to:
encode the CG-UCI into a first block;
encode the low priority CSI into a second block; and
multiplex the first block and the second block with the data.

24. The UE of claim 17, wherein:
the low-priority UCI comprises at least one of a low-priority hybrid automatic repeat request-acknowledgement (HARQ-ACK) or low-priority channel state information (CSI),
the high-priority UCI comprises a high-priority HARQ-ACK,
the processor is further configured to:
refrain, based on a multiplexing configuration being disabled, from transmitting the high-priority CG-PUSCH,
the processor configured to multiplex comprises the processor configured to:
generate a first block by appending the low-priority UCI to the high-priority HARQ-ACK; and
encode the first block, and
the transceiver configured to transmit comprises transceiver configured to:
transmit, based on the multiplexing configuration being disabled, the multiplexed uplink transmission in a PUCCH resource.

25. The UE of claim 24, wherein:
the low-priority UCI comprises the low-priority HARQ-ACK and the low-priority CSI, and
the processor configured to generate the first block further comprises the processor configured to:
append the low-priority HARQ-ACK to the high-priority HARQ-ACK;
append the low-priority CSI to the low-priority HARQ-ACK.

26. The UE of claim 17, wherein:
the low-priority CG-PUSCH transmission comprises CG-UCI and data,
the low-priority UCI comprises a low-priority HARQ-ACK,
the high-priority UCI comprises a high-priority HARQ-ACK,
the processor configured to multiplex comprises the processor configured to:
encode, based on a multiplexing configuration being enabled, the high-priority HARQ-ACK with the low-priority HARQ-ACK and the CG-UCI into an encoded block, the processor configured to encode the high-priority HARQ-ACK with the low-priority HARQ-ACK comprising the processor configured to:
generate a first block by appending the low-priority HARQ-ACK to the CG-UCI and appending the high-priority HARQ-ACK to the low-priority HARQ-ACK; and
encode the first block; and
multiplex the encoded block with the data, and
the transceiver configured to transmit comprises the transceiver configured to:
transmit the multiplexed uplink transmission in a low-priority CG-PUSCH resource.

27. The UE of claim 17, wherein:
the low-priority UCI comprises at least one of a low-priority hybrid automatic repeat request-acknowledgement (HARQ-ACK) or low-priority channel state information (CSI),
the high-priority UCI comprises a high-priority HARQ-ACK,
the processor is further configured to:
refrain, based on a multiplexing configuration being disabled, from transmitting the low-priority CG-PUSCH transmission,
the processor configured to multiplex comprises the processor configured to:
generate a first block by appending the low-priority UCI to the high-priority HARQ-ACK; and
encode the first block, and
the transceiver configured to transmit comprises the transceiver to:
transmit, based on the multiplexing configuration for multiplexing CG-PUSCH and HARQ-ACK being disabled, the multiplexed uplink transmission in a PUCCH resource.

28. The UE of claim 27, wherein:
the low-priority UCI comprises the low-priority HARQ-ACK and the low-priority CSI, and
the processor configured to generate the first block further comprises the processor configured to:
append the low-priority HARQ-ACK to the high-priority HARQ-ACK; and
append the low-priority CSI to the low-priority HARQ-ACK.

29. A non-transitory, computer-readable medium having program code recorded thereon, the program code comprising:
code for causing a user equipment (UE) to determine that a physical uplink control channel (PUCCH) resource at least partially overlaps with a configured grant physical uplink shared channel (CG-PUSCH) resource, wherein the PUCCH resource and the CG-PUSCH resource are associated with different priorities;
code for causing the UE to determine, based on a threshold number of bits, a number of bits of a low-priority uplink control information (UCI) for multiplexing with at least one of a high-priority CG-PUSCH transmission, a low-priority CG-PUSCH transmission, or a high-priority UCI; and
code for causing the UE to multiplex the number of bits of the low-priority UCI with the at least one of the high-priority CG-PUSCH transmission, the low-priority CG-PUSCH transmission, or the high-priority UCI to generate a multiplexed uplink transmission; and
code for causing the UE to transmit the multiplexed uplink transmission in the PUCCH resource or the CG-PUSCH resource.

30. A user equipment (UE), comprising:
means for determining that a physical uplink control channel (PUCCH) resource at least partially overlaps with a configured grant physical uplink shared channel (CG-PUSCH) resource, wherein the PUCCH resource and the CG-PUSCH resource are associated with different priorities;
means for determining, based on a threshold number of bits, a number of bits of a low-priority uplink control information (UCI) for multiplexing with at least one of a high-priority CG-PUSCH transmission, a low-priority CG-PUSCH transmission, or a high-priority UCI;
means for multiplexing the number of bits of the low-priority UCI with the at least one of the high-priority CG-PUSCH transmission, the low-priority CG-PUSCH transmission, or the high-priority UCI to generate a multiplexed uplink transmission; and
means for transmitting the multiplexed uplink transmission in the PUCCH resource or the CG-PUSCH resource.
